(19) United States
(12) Patent Application Publication
(10) Pub. No.: US 2026/0200632 A1
(43) Pub. Date: Jul. 16, 2026

(54) SKELETON CONTAINER

(71) Applicant: Kari-Out LLC, Tarrytown, NY (US)

(72) Inventors: Gage Walker, Ballston Spa, NY (US); Paul Epstein, Larchmont, NY (US)

(21) Appl. No.: 19/440,702

(22) Filed: Jan. 6, 2026

Related U.S. Application Data
(60) Provisional application No. 63/744,718, filed on Jan. 13, 2025.

(51) Int. Cl. B65D 8/00; B31B 50/62; B65D 21/02; B65D 43/02; B65D 43/16; B65D 51/16; B31B 105/00; B31B 120/10

(52) U.S. Cl. CPC B65D 15/22; B31B 50/62; B65D 15/24; B65D 21/022; B65D 43/022; B65D 43/162; B65D 51/1605; B31B 2105/00; B31B 2120/102; B65D 2543/00194; B65D 2543/00231; B65D 2543/00268; B65D 2543/00296; B65D 2543/00314

(57) ABSTRACT

A food container and methods of making the same are disclosed. Example food containers may include a tray defining a volume for receiving a food item, and a lid configured to enclose the volume of the tray along a liquid-proof interface between the lid and the tray. The tray may include a plurality of tray panels formed of a first material, and a tray skeleton structure joining adjacent edges of the panels to form one or more corners. The lid may include one or more lid panels formed of the first material, and a lid skeleton structure forming a perimeter of the lid. The skeleton structures of the tray and the lid may be formed of a second material different from the first material.

### CROSS-REFERENCE

This application claims priority to U.S. Provisional Patent Application No. 63/744,718, filed on January 13, 2025, the contents of which are hereby expressly incorporated by reference in their entirety for all purposes.

### BACKGROUND

Disposable or limited-use carry out food containers are used in a wide variety of environments and use cases, such as at self-service salad bars or hot-food bars at grocery stores and food courts, as take-out containers for restaurant take-out or delivery (e.g., from “ghost kitchens”), at temporary eateries such as pop-ups or food trucks, for dispensing bulk items such as at bulk-food stores or farmers markets, and a variety of home applications such as travel or picnics. These are just examples of dozens of common uses for disposable or limited use food containers (hereinafter, “carry out containers” or “food containers”). Many of these use cases involve initially receiving food to be consumed in the food container, temporarily enclosing the food in the food container, and transporting the food in the food container to another location such as a table, park, office, or home to be consumed.

Food containers may be made environmentally friendly in various ways, such as through use of materials that are compostable or otherwise have minimal net environmental impact, e.g., fibrous or paper-based materials. However, fibrous materials may be relatively less durable than plastic or polymer materials, particularly in response to moisture. While attempts have been made to incorporate stronger materials such as plastics to reinforce into containers employing fibrous materials, such containers fail to provide an adequate seal between interfaces of food-containing trays and corresponding lids. Accordingly, there is a need for an environmentally friendly container that addresses these shortcomings.

### SUMMARY

In at least some example approaches herein, a food container comprises a tray defining a volume for receiving a food item. The tray includes a plurality of tray panels formed of a first material. The tray also comprises a tray skeleton structure joining adjacent edges of the panels to form one or more corners. The skeleton structure is formed of a second material different from the first material. The food container also includes a lid configured to enclose the volume of the tray along a liquid-proof interface between the lid and tray. The lid includes one or more lid panels formed of the first material. The lid also includes a lid skeleton structure forming a perimeter of the lid, the lid skeleton structure formed of a second material different from the first material.

In at least some of the foregoing example food containers, four tray panels are provided, with the tray skeleton structure joining adjacent edges of the panels to form four corners, and the lid skeleton structure defining four corners corresponding to the four corners of the tray.

In at least some example illustrations, a method of making a food container comprises forming a tray defining a volume for receiving a food item, including providing a plurality of tray panels and joining adjacent edges of the plurality of tray panels with a tray skeleton structure to form one or more tray corners. The method further comprises forming a lid configured to enclose the volume of the tray along a liquid-proof interface between the lid and tray. More specifically, the method includes providing one or more lid panels, and adhering edges of the one or more lid panels to a lid skeleton structure to form one or more lid corners. The tray panels and the one or more lid panels may each be formed of a fibrous material, and the tray skeleton structure and the lid skeleton structure may be each formed of a resin material.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1A shows a top perspective view of a bottom/tray of a skeleton food container in accordance with an embodiment of the present disclosure;

FIG. 1B shows a top view of the bottom of the skeleton food container of FIG. 1A in accordance with an embodiment of the present disclosure;

FIG. 1C shows a bottom view of the tray of a skeleton food container in accordance with an embodiment of the present disclosure:

FIG. 1D depicts a side view of the tray of the skeleton food container in accordance with an embodiment of the present disclosure;

FIG. 1E depicts another side view of the tray of the skeleton food container in accordance with an embodiment of the present disclosure;

FIG. 1F shows a top perspective view of a skeleton food container top/lid in accordance with an embodiment of the present disclosure;

FIG. 1G shows a bottom perspective view of a skeleton food container lid in accordance with an embodiment of the present disclosure;

FIG. 1H shows a cross-sectional side view of two trays of a skeleton food container nested within each other in accordance with an embodiment of the present disclosure;

FIG. 1I shows stacked skeleton food containers in accordance with an embodiment of the present disclosure:

FIG. 2A shows a top view of skeleton food container in a closed configuration where the tray and the lid are connected by a hinge in accordance with another embodiment of the present disclosure;

FIG. 2B shows a bottom view of a skeleton food container in a closed configuration where the tray and the lid are connected by a hinge in accordance with another embodiment of the present disclosure;

FIG. 2C shows a top view of a skeleton food container in an open configuration where the tray and the lid are connected by a hinge in accordance with another embodiment of the present disclosure;

FIG. 2D shows a bottom view of a skeleton food container in an open configuration where the tray and the lid are connected by a hinge in accordance with another embodiment of the present disclosure;

FIG. 3A shows a top view of a skeleton food container tray and lid in a closed configuration where the tray has bottom corner stops in accordance with another embodiment of the present disclosure;

FIG. 3B shows a bottom view of a skeleton food container tray where the tray has bottom corner stops in accordance with another embodiment of the present disclosure;

FIG. 3C shows two skeleton food containers stacked on top of one another with a tray and a lid in a closed configuration where the tray has bottom corner stops that are used to facilitate stacking in accordance with another embodiment of the present disclosure;

FIG. 4A shows a top perspective view of a tray of a skeleton food container in accordance with another embodiment of the present disclosure;

FIG. 4B shows a bottom perspective view of a tray of a skeleton food container in accordance with another embodiment of the present disclosure;

FIG. 4C shows a top view of a flattened blank for the tray of the skeleton container of FIGS. 4A and 4B prior to assembly in accordance with another embodiment of the present disclosure;

FIG. 5A shows a top perspective view of a tray of a skeleton food container in accordance with another embodiment of the present disclosure;

FIG. 5B shows a bottom perspective view of the skeleton food container tray shown in FIG. 5A in accordance with another embodiment of the present disclosure;

FIG. 5C shows a cross-section view of the tray of FIGS. 5A and 5B where a perimeter channel is shown in accordance with another embodiment of the present disclosure;

FIG. 5D shows a top perspective of a lid of a skeleton food container secured on the skeleton food container tray shown in FIGS. 5A-5C;

FIG. 5E shows a bottom perspective of the lid of the skeleton food container shown in FIG. 5D in accordance with another embodiment of the present disclosure; and

FIG. 6 shows a process flow diagram for a method of making a food container, in accordance with an embodiment of the present disclosure.

### DETAILED DESCRIPTION

Example food containers herein are generally configured to securely house and protect food items, offering structural strength and additional features to enhance its usability and functionality. Examples herein also offer a relatively more liquid-proof interface between separate components of a food container such as a tray and lid than in previous approaches. Example food containers may generally utilize multiple components, e.g., a tray and lid, with the tray and lid each having a hybrid or multiple-material construction. For example, a skeleton structure of a first material may be provided that joins panels formed of a second/different material.

Example food containers may have a tray that defines a volume to receive food items for storage and/or eating, with the lid being configured to enclose the volume. The lid may be removed or opened to facilitate consumption of the food item(s) from the tray.

In at least some example approaches, the tray and the lid are both constructed using a generally hybrid design that employs a first material and a second material. The first material may be used to form one or more panels, which define primary surfaces of the tray/lid, e.g., bottom, side, and/or top panels. This first material, which may be fibrous or paper-based (e.g., cardboard) may provide a lightweight and sustainable structure. The second material, a resin or plastic, may form a skeleton structure that joins edges of the panel(s), and may reinforce corners and enhancing structural integrity of the tray/lid. This dual-material construction may generally maximize sustainability and durability, making the lid and tray of the container robust yet environmentally friendly.

Additionally, example illustrations may also employ a lid and tray construction that reduces or eliminates leaks, e.g., of moisture from food items contained within a container when the lid is closed on the tray. For example, an interface between a lid and a tray may include male/female features, thereby reducing a likelihood of moisture or liquid penetrating through the interface between the lid and tray. In other examples, interface regions between a lid and a tray may include multiple pairs of mated surfaces positioned at angles relative to each other, or otherwise undulating or forming generally “stair”-shaped surfaces. The lid may be provided with a corresponding corner or male member abutting against adjacent angled surfaces, thereby providing a seal against both. As a result, liquid must traverse multiple pairs of surfaces engaged or abutted together. By comparison, previously existing “cap-over” designs for food containers generally lack such mating features, and as a result moisture penetrates an interface between the lid and tray, resulting in an inferior seal.

Additionally, in example illustrations herein edges of fibrous materials may be coated with non-fibrous materials, further reducing leakage of moisture or liquids from the container. For example, skeleton structures formed of resin or plastic materials may extend along edges of a fibrous panel, and as resin and/or plastic materials are typically more robust than fiber-based materials at preventing moisture from penetrating. Accordingly, coating fibrous materials with resin or plastic materials may increase overall moisture-penetration preventing properties of the food container. Further, in some examples edges of fibrous panels may be adhered to the skeleton structures to further reduce a likelihood of moisture penetrating seams between adjacent panels.

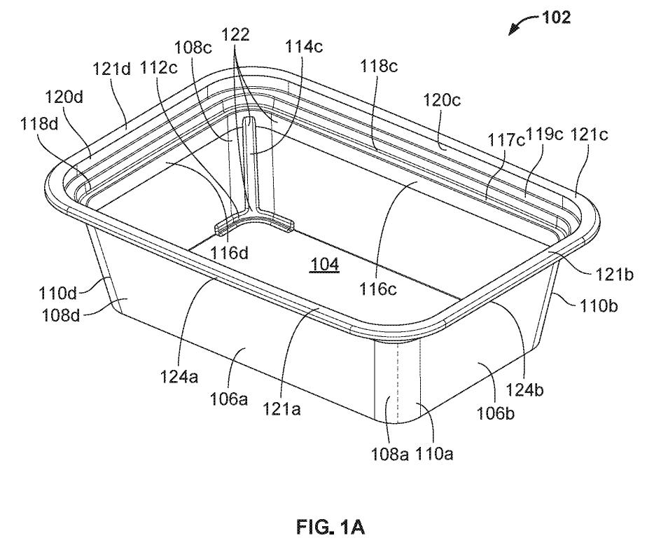

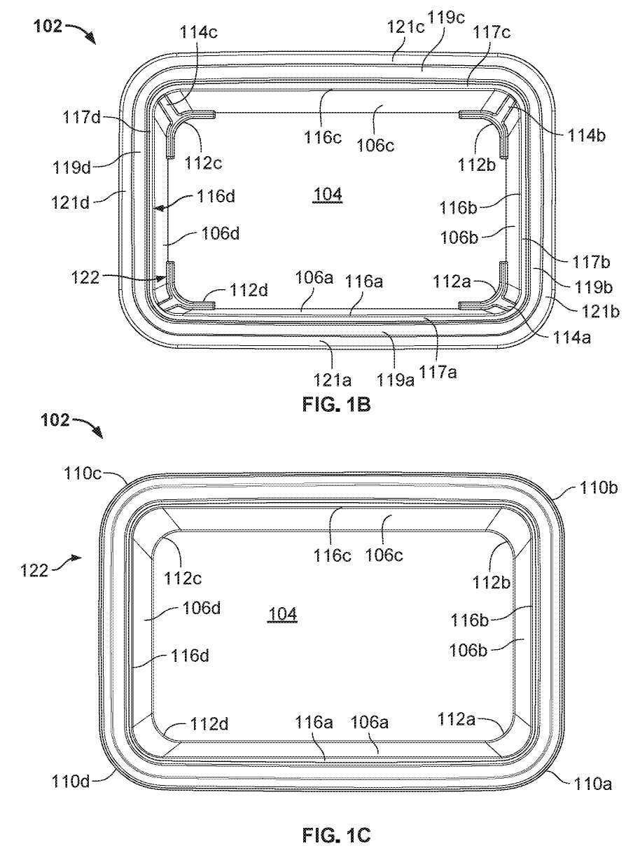

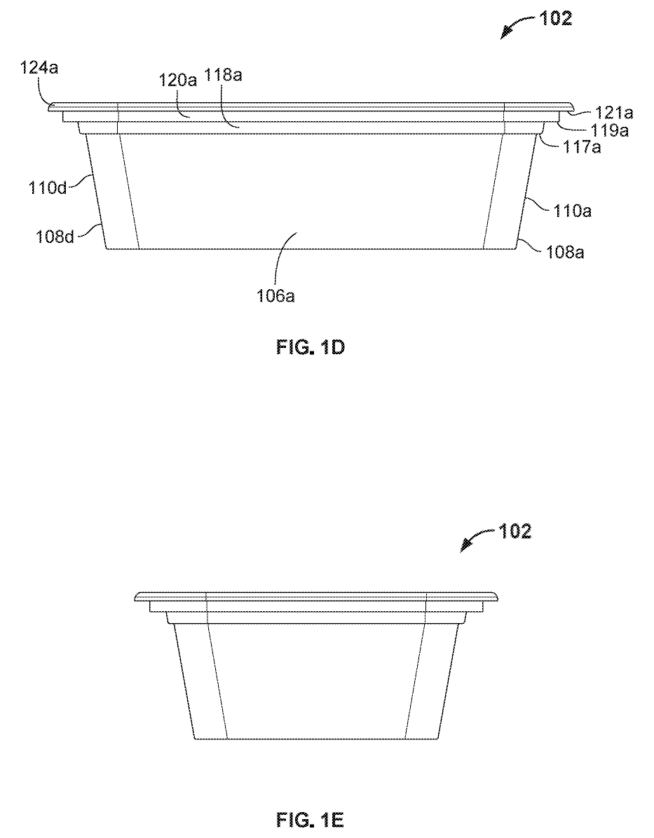

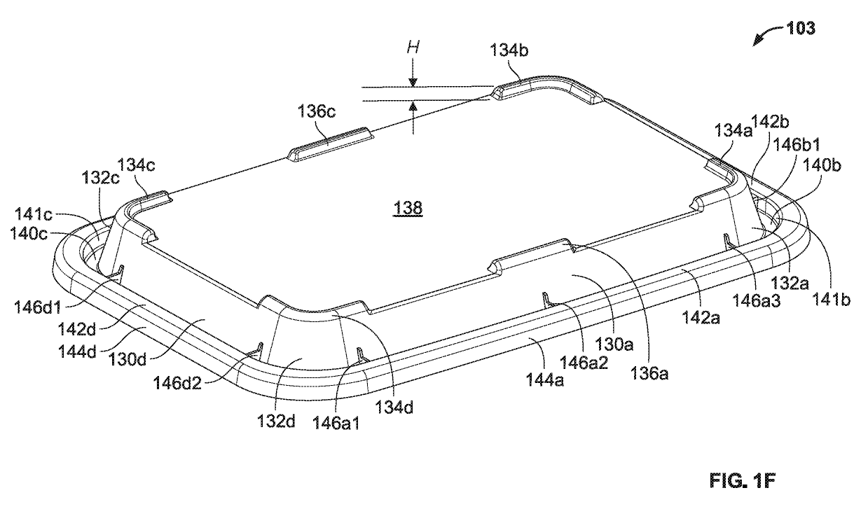

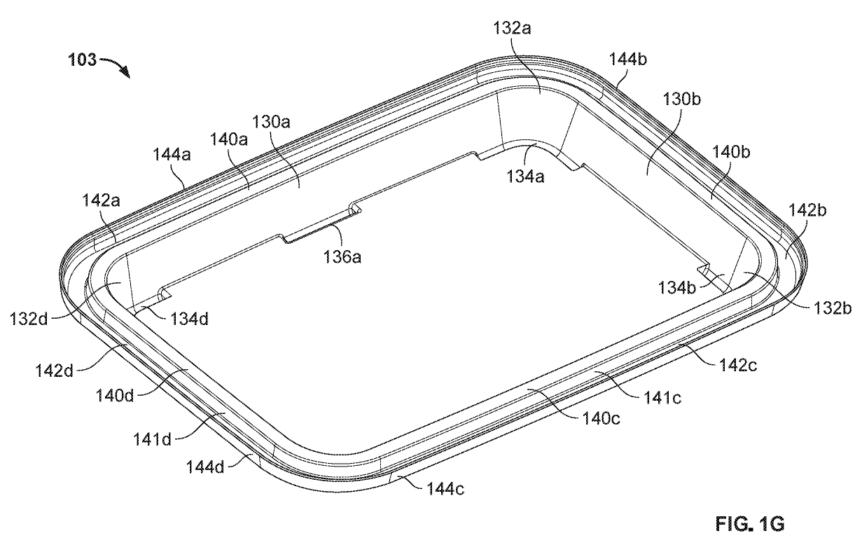

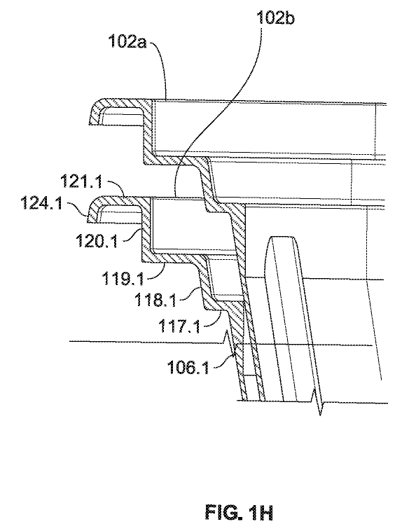

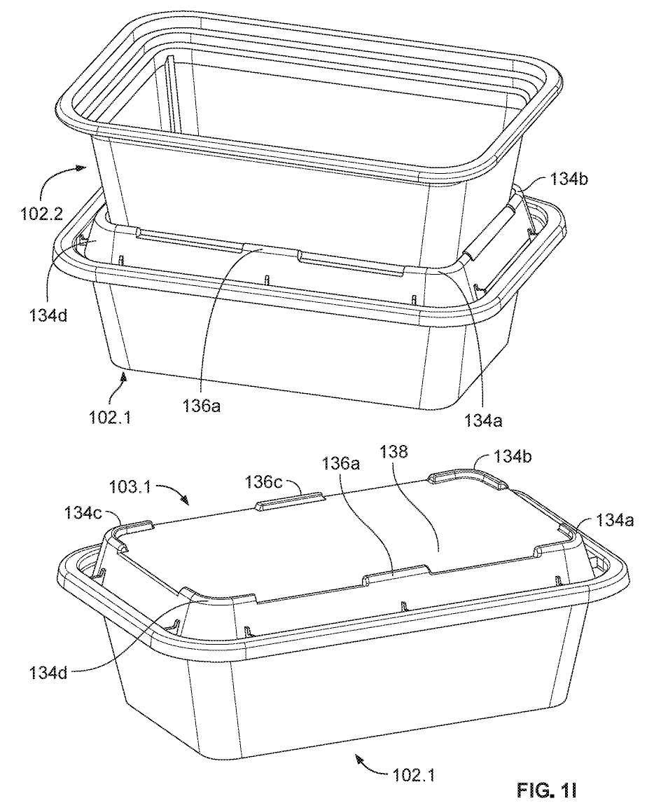

Referring now to FIGS. 1A-1I of the appended drawings, an example food container 100 is illustrated comprising a separately formed tray 102 (FIGS. 1A-1E and 1H) and an interfacing lid 103 (FIGS. 1F, 1G, and 1I). Both the tray 102 and lid 103 employ a skeleton structure formed of a first material, e.g., a resin or plastic material, which supports panel(s) formed of a second material, e.g., a fibrous or paper-based material.

Generally, edges where panels formed of a first material (e.g., a fibrous material) meet may be joined by a skeleton structure formed of a second material (e.g., a plastic or resin material), which generally reinforces corners of the tray and defines an overall shape of the container. Example skeleton structures may include a lid-engaging portion along an uppermost region of the tray, and multiple posts extending vertically downward from the lid-engaging portion. The posts may define a widened foot area at a lower-most end of the posts, e.g., where the posts meet the bottom panel of the fibrous material.

The skeleton structure may generally enhance rigidity of the tray, as may be useful for relatively heavy or moist food items. The skeleton structure also typically forms multiple corners of the tray. While the tray is often constructed with four panels extending upward from a lower horizontal base panel to ensure geometric simplicity and strength, with posts positioned in each corner, other examples may use different shapes or configurations.

Example methods of making food containers as described herein may generally facilitate a food container designed to securely house food items while ensuring structural integrity and liquid-proof functionality. As noted above, example containers may be composed of a tray and a lid, both constructed using a combination of materials, e.g., a fibrous panel(s) joined together by a resin-based skeleton structure. The method ensures precise assembly and durability, optimizing the container for practical use in food storage and transportation.

In an example method, the tray may be formed to define a volume for receiving and holding a food item. As will be described further below, to construct the tray a plurality of tray panels may be provided. These panels are composed of a fibrous material, such as cardboard or other paper-based substrates, chosen for their lightweight properties, environmental sustainability, and ease of manufacturing. Each tray panel is cut and shaped to predetermined dimensions, ensuring a snug fit when assembled. The tray panels typically include a horizontally extending bottom panel and a plurality of vertically extending side panels that will define the tray's walls and open top. Example approaches may employ a single sheet including a horizontally extending lower panel and one or more side panels, which may be formed by folding the side panels relative to the lower/horizontal panel.

The adjacent edges of the tray panels may then be joined using a tray skeleton structure, e.g., formed from a resin material such as plastic. The skeleton structure, as noted above, serves as a relatively rigid framework that connects the panels at their edges and forms robust corners. This step may involve molding or extruding the resin material to create corner reinforcements and linear connectors that align and secure the panels. The tray skeleton structure ensures the assembled tray is durable, resistant to deformation, and capable of withstanding the weight and moisture of food items. By combining the flexibility and sustainability of fibrous materials with the strength of resin, the resulting tray achieves an optimal balance of performance and eco-friendliness.

The method may also include forming the lid, which is designed to enclose the tray's volume along a liquid-proof interface. Similar to the tray, the lid is constructed by first providing a plurality of lid panels made of the same fibrous material. The lid panels typically include a horizontally extending top panel and a plurality of side panels that extend downward to overlap with the upper edges of the tray when closed. These panels are cut and shaped to fit the tray’s dimensions, ensuring a secure seal when the lid is applied. To the extent a lid includes multiple panels, a single sheet of the fibrous material may be cut with side panels of the lid being folded relative to a main/upper horizontally extending surface.

Adjacent edges of the lid panels may be joined using a lid skeleton structure, also formed from a resin material. The lid skeleton structure may be molded or extruded to form connectors and corner reinforcements, similar to those used for the tray. These connectors may align and secure the lid panels, forming robust corners that enhance the lid’s rigidity and ensure it retains its shape during handling and storage. The lid skeleton structure may also include additional features, such as protrusions that extend above the top panel to form corner stops, as noted above. These corner stops may interact with the edges of the tray to prevent horizontal movement and ensure a stable stacking of adjacent food containers.

Generally, fibrous materials as used herein may include paper, paperboard, cardboard, molded fibers, or pulp materials. These fibrous materials may be coated or treated as desired, e.g., to prevent leakage of liquid or viscous portions of the food items, to absorb moisture, or to insulate to retain temperature, merely as examples. In some examples, a fibrous material is a paperboard or corrugated sheet material. Other materials may be used if desired. In embodiments utilizing paperboard, the paperboard may be virgin or recycled material, may be coated or uncoated, and may be single-ply or laminated paperboard. The paperboard may be coated with a suitable food grade material to reduce leakage, such as a polyester resin film. Optionally, the side of the paperboard blank that forms the interior surface of the resulting tray is coated with a liquid impervious polymer film. Optionally, the blank is coated on one side, which will serve as the inside surface of the resulting container, with a clay-coat, which is cured with a UV or electron beam varnish.

Skeleton structures described herein may be formed of materials different from the fibrous materials that typify primary panels of the tray and/or lid. Generally, these materials may be directed to resins, plastics, or other materials that are typically stronger and/or more durable than the fibrous materials described above. For example, polymer, resin or plastic materials may be relatively more resistant to weakening from exposure to moisture in a food item or steam emanating from a food item. In an example, the resin material is a biodegradable polymer material such as a polylactic acid (PLA) material. In at least some examples, skeleton structure materials may include those materials generally used in injection molding. For example, the aforementioned PLA material may be injection molded. In other examples, Polyethylene (PE), Acrylonitrile Butadiene Styrene (ABS), or High Impact Polystyrene (HIPS) materials may be used.

Example constructions for tray/lid components may use fibrous or paper-based panels formed in a sheet and folded to form panels, e.g., of a tray. Folds and seams of the fibrous panels may be supported by example skeleton structures, e.g., by adhering panels to the skeleton structure along edges of the panels. To the extent fibrous panels are coated, coating materials may be matched to polymer/resin material of the skeleton structure, to thereby promote adhesion of the fibrous panels to the skeleton structure. For example, a polymer coating may be applied to a fibrous portion of a panel or container, which is the same as a polymer used for a skeleton structure or portion thereof, which may thereby promote an in-mold bonding of the two materials.

FIG. 1A shows a top perspective view of a tray 102 of a skeleton food container 100 in accordance with an embodiment of the present disclosure. Although the tray 102 may include a variety of components, and one or more components may be added, removed, or modified in different embodiments, in the exemplary embodiment of FIG. 1A, components of the tray102 can include a tray bottom panel 104, a plurality of tray side panels 106, a plurality of tray side panel seams 108, a plurality of corners 110, a plurality of feet 112, a plurality of vertically extending posts 114, a skeleton perimeter wall 116, a plurality of perimeter walls 118, 120, a plurality of laterally extending surfaces 117, 119, 121, a plurality of lid-engaging portions 124. In FIG. 1A the skeleton structure 122 includes the plurality of skeleton perimeter walls 116, feet 112, and vertically extending posts 114. It will be understood that the specific depicted relative dimensions and proportions are exemplary only, and that the present disclosure applies to a variety of food container shapes. These shapes can include squares, rectangles, circles, ovals, polygons and irregular shapes, as may suit a particular end use application (e.g., customized shapes for particular food items). The sizes of the skeleton food container 100 can also vary from small enough to carry a single food serving to carrying multiple food portions for serving multiple people, and may include multiple internal sub-compartments and/or externally attached sub-compartments. The skeleton food container 100 can be made from various types of materials including paper, cardboard, molded fibers, pulp, light metal (e.g., light aluminum), plastics/polymers, bioplastics, styrofoam, and combinations of materials (e.g., a cardboard container having a plastic skeleton structure or having plastic “windows” on one or more sides). The skeleton container 100 material can include various treatments or coatings suitable for particular applications, such as to prevent leakage of liquid or viscous portions of the food items, to absorb moisture, to insulate to retain temperature, to provide structural integrity, etc.

The tray 102 as shown in FIG. 1A is generally rectangular in shape with four tray side panels 106a, 106b, 106c, and 106c. Each tray side panel 106a/106b/106c/106d is connected to two adjacent tray side panels via a tray side panel seam 108a/108b/108c/108d, thereby forming four corners 110a/110b/110c/110d (i.e., tray side panel 106a is connected to tray side panel 106b via tray side panel seam 108a and forming corner 110a, tray side panel 106a is connected to tray side panel 106d via tray side panel seam 108d and forming corner 110d, tray side panel 106b is connected to tray side panel 106c via tray side panel seam 108b and forming corner 110b, tray side panel 106c is connected to tray side panel 106d via tray side panel seam 108c and forming corner 110c). Tray bottom panel 104 is connected to a lower end of each tray side panel 106a/106b/106c/106d at their respective sides to form a lower portion of an enclosed container (in cooperation with the lid 103). The tray bottom panel 104 and the tray side panels 106 can be formed in one single, monolithic piece or a continuously extending material, e.g., where the side panels 106 are created by folding each side panel upwards. Alternatively, the tray bottom panel 104 can be formed as a separate piece subsequently attached to the tray side panels 106 to form the tray 102. The tray bottom panel 104 can be attached to the side panels 106 by various adhesives or any other method that is convenient.

In the example tray 102 of FIG. 1A, a skeleton structure 122 is provided, which is positioned in an interior of the tray 102. The skeleton structure has four feet 112a/112b/112c/ 112d, four vertically extending posts 114a/114b/114c/114d (only foot 112c and vertically extending post 114c are visible in FIG. 1A), and 4 skeleton perimeter walls 116a/116b/ 116c/116d (only skeleton perimeter walls 116c and 116d are visible in FIG. 1A). The skeleton structure 122, including the feet 112, posts 114, and walls 116, can be formed in a single monolithic piece. Alternatively, components of the skeleton structure 112 may be formed in multiple pieces and subsequently joined. The components of the skeleton structure 122 are generally flush with respect to the interior of the tray 102. The skeleton structure 122 can be positioned inside the tray 102 in direct contact with the perimeter walls 116. The skeleton structure 122 could also be adhered to the tray 102 by a food-safe adhesive or it can be imbedded within the tray 102. In still another example, the skeleton structure 122 may be molded over panels 106 of the tray 102.

While foot 112c is visible in FIG. 1A and feet 112a, 112b, and 112d are not visible, it should be understood that each foot 112a/112b/112c/112d is connected to its respective vertically extending post 114a/114b/114c/114d (e.g., foot 112a is connected to vertically extending post 114a, foot 112b is connected to vertically extending post 114b, foot 112c is connected to vertically extending post 114c and foot 112d is connected to vertically extending post 114d). Similarly, each vertically extending post 114a/114b/114c/114d is connected to two skeleton perimeter walls 116a/116b/116c/ 116d (e.g., vertically extending post 114a is connected to skeleton perimeter walls 116a and 116b, vertically extending post 114b is connected to skeleton perimeter walls 116b and 116c, vertically extending post 114c is connected to skeleton perimeter walls 116c and 116d and vertically extending post 114d is connected to skeleton perimeter walls 116d and 116a).

As shown in FIG. 1A, the feet 112a/112b/112c/112d of the skeleton structure 122 extend within a lowermost end of each respective inside corner 110a/110b/110c/110d (e.g., foot 112a runs along the inside of corner 110a, with one side of its foot running along the bottom of the inside of tray side panel 106a and the other side of its foot running along the bottom of the inside of tray side panel 106b, foot 112b runs along the inside of corner 110b, with one side of its foot running along the bottom of the inside of tray side panel 106b and the other side of its foot running along the bottom of the inside of tray side panel 106c, foot 112c runs along the inside of corner 110c, with one side of its foot running along the bottom of the inside of tray side panel 106c and the other side of its foot running along the bottom of the inside of tray side panel 106d, and foot 112d runs along the inside of corner 110d, with one side of its foot running along the bottom of the inside of tray side panel 106d and the other side of its foot running along the bottom of the inside of tray side panel 106a). The vertically extending posts 114a/114b/114c/ 114d intersect their respective feet 112a/112b/112c/112d perpendicularly and extend upwardly along the inside of the respective corners 110a/110b/110c/110d, ending at the junction of the two corresponding skeleton perimeter walls 116a/116b/116c/116d.

The skeleton structure 122 can be made of a first material, e.g., a resin or plastic material, which supports panel(s) formed of a second material, e.g., a fibrous or paper-based material. Generally, fibrous materials as used herein may include paper, paperboard, cardboard, molded fibers, or pulp materials. These fibrous materials may be coated or treated as desired, e.g., to prevent leakage of liquid or viscous portions of the food items, to absorb moisture, or to insulate to retain temperature, merely as examples. In some examples, a fibrous material is a paperboard or corrugated sheet material. Other materials may be used if desired. In embodiments utilizing paperboard, the paperboard may be virgin or recycled material, may be coated or uncoated, and may be single-ply or laminated paperboard. The paperboard may be coated with a suitable food grade material to reduce leakage, such as a polyester resin film. Optionally, the side of the paperboard blank that forms the interior surface of the resulting tray is coated with a liquid impervious polymer film. Optionally, the blank is coated on one side, which will serve as the inside surface of the resulting container, with a clay-coat, which is cured with a UV or electron beam varnish.

Skeleton structures described herein may be formed of materials different from the fibrous materials that typify primary panels of the tray and/or lid. Generally, these materials may be directed to resins, plastics, or other materials that are typically stronger and/or more durable than the fibrous materials described above. For example, polymer, resin or plastic materials may be relatively more resistant to weakening from exposure to moisture in a food item or steam emanating from a food item. In an example, the resin material is a biodegradable polymer material such as a polylactic acid (PLA) material.

Example constructions for tray/lid components may use fibrous or paper-based panels formed in a sheet and folded to form panels, e.g., of tray102. Folds and seams of the fibrous panels may be supported by example skeleton structures, e.g., by adhering panels to the skeleton structure along edges of the panels, molding-in edges of the panels to the skeleton structure, or the like. To the extent fibrous panels are coated, coating materials may be matched to polymer/resin material of the skeleton structure, to thereby promote adhesion of the fibrous panels to the skeleton structure.

An upper end of the tray 102 has four perimeter skeleton walls 116 (116a, 116b, 116c, 116d) and two additional perimeter walls 118 (118a, 118b, 118c, and 118d) and 120 (120a, 120b, 120c, 120d) and their corresponding laterally extending surfaces 117 (117a, 117b, 117c, 117d), 119 (119a, 119b, 119c, 119d), and 121 (121a, 121b, 121c, 121d). In FIG. 1A, skeleton perimeter walls 116a, 116b, perimeter walls 118a, 118b, 120a, 120b and laterally extending surfaces 117a, 117b, 119a, 119b are not shown. Skeleton perimeter walls 116a/116b/116c/116d generally extend about an upper perimeter of the tray 102. The perimeter walls 116/118/120 and laterally extending surfaces 117/119/121 generally form a stair-shaped structure. For example, first laterally extending surfaces 117a/117b/117c/117d abut their respective corresponding skeleton perimeter wall 116a, 116b, 116c, 116d at a right angle (e.g., laterally extending surface 117a abuts the entire length of skeleton perimeter wall 116a at a right angle, laterally extending surface 117b abuts the entire length of skeleton perimeter wall 116b at a right angle, laterally extending surface 117c abuts the entire length of skeleton perimeter wall 116c at a right angle and laterally extending surface 117d abuts the entire length of skeleton perimeter wall 116d at a right angle). Perimeter walls 118a/118b/118c/118d abut laterally extending surface 117a/117b/117c/117d and form a right angle with the laterally extending surface 117a/117b/117c/117d (e.g., perimeter wall 118a abuts vertically to laterally extending surface 117a forming a right angle, perimeter wall 118b abuts vertically to laterally extending surface 117b forming a right angle, perimeter wall 118c abuts vertically to laterally extending surface 117c forming a right angle, and perimeter wall 118d abuts vertically to laterally extending surface 117d forming a right angle). A second laterally extending surface 119a/119b/119c/119d, abuts their respective corresponding perimeter wall 118a/118b/118c/118d at a right angle (e.g., laterally extending surface 119a abuts the entire length of perimeter wall 118a at a right angle, laterally extending surface 119b abuts the entire length of perimeter wall 118b at a right angle, laterally extending surface 119c abuts the entire length of perimeter wall 118c and laterally extending surface 119d abuts the entire length of perimeter wall 118d). Perimeter walls 120a/120b/120c/120d abut vertically laterally extending surface 119a/ 119b/119c/119d and form a right angle with the laterally extending surface 119a/119b/ 119c/119d (e.g., perimeter wall 120a abuts vertically to laterally extending surface 119a forming a right angle, perimeter wall 120b abuts vertically to laterally extending surface 119b forming a right angle, perimeter wall 120c abuts vertically to laterally extending surface 119c forming a right angle, and perimeter wall 120d abuts vertically to laterally extending surface 119d forming a right angle). A third laterally extending surface 121a/ 121b/121c/121d, abuts their respective corresponding perimeter wall 120a/120b/120c/ 120d at a right angle (e.g., laterally extending surface 121a abuts the entire length of perimeter wall 120a at a right angle, laterally extending surface 121b abuts the entire length of perimeter wall 120b at a right angle, laterally extending surface 121c abuts the entire length of perimeter wall 120c and laterally extending surface 121d abuts the entire length of perimeter wall 120d). Around the perimeter of the third laterally extending surface 121a/121b/121c/121d is a lid-engaging portion 124a/124b/124c/124d. The lid-engaging portion 124a/124b/124c/124d (124c and 124d are not visible in FIG. 1A) abuts the laterally extending surface 121a, 121b, 121c, 121d and extends downward from it (e.g., lid-engaging portion 124a abuts laterally extending surface 121a and extends downward from laterally extending surface 121a, lid-engaging portion 124b abuts laterally extending surface 121b and extends downward from laterally extending surface 121b, lid-engaging portion 124c abuts laterally extending surface 121c and extends downward from laterally extending surface 121c, and lid-engaging portion 124d abuts laterally extending surface 121d and extends downward from laterally extending surface 121d). The lid-engaging portion 124 generally creates a seal with a lid (not shown in FIG. 1A) of the skeleton food container 100.

The combination of multiple perimeter walls 116, 118, 120 and multiple laterally extending surfaces 117, 119, 121 abutting each other consecutively at right angles forms a stair-step shape or formation around the perimeter of the top of the tray 102. Although FIG. 1A shows three “steps”, i.e., three laterally extending surfaces 117, 119, 121), any number can be used. Further, although FIG. 1A shows that only the first perimeter wall is the skeleton material 116, the skeleton material can also be any number of the laterally extending surfaces 117, 119, 121 and any number of the perimeter walls 118, 120. As will be discussed in FIGS. 1F and 1G, in more detail with respect to the lids of the skeleton food container 100, this stair step formation on the top of the tray 102 along with the lid-engaging portion 122 may facilitate a liquid-tight seal when combined with a similar stair step formation in a corresponding lid of the skeleton food container100.

Skeleton perimeter walls 116a/116b/116c/116d (barely visible in FIG. 1C) may generally extend along an upper perimeter of the tray 102 (e.g., skeleton perimeter wall 116a runs along the top of side panel 106a, skeleton perimeter wall 116b runs along the top of side panel 106b, skeleton perimeter wall 116c runs along the top of side panel 106c, and skeleton perimeter wall 116d runs along the top of side panel 106d). The four skeleton perimeter walls 116a, 116b, 116c, 116d are connected to form a continuous rectangle along the top of the tray 102 (e.g., skeleton perimeter wall 116a connects to skeleton perimeter wall 116b and 116d, skeleton perimeter wall 116b connects to skeleton perimeter wall 116a and 116c, skeleton perimeter wall 116c connects to skeleton perimeter wall 116b and 116d and skeleton perimeter wall 116d connects to skeleton perimeter wall 116c and 116a).

FIG. 1C shows a bottom view of the bottom of a skeleton food container in accordance with an embodiment of the present disclosure. As shown in FIG. 1C, the feet 112a/112b/112c/112d of the skeleton structure 122 are visible on the bottom or underside of the skeleton food container 102, and extend along the inside of the bottom of each respective inside corner 110a/110b/110c/110d (i.e., foot 112a runs along the inside of corner 110a, with one side of its foot running along the bottom of the inside of tray side panel 106a and the other side of its foot running along the bottom of the inside of tray side panel 106b, foot 112b runs along the inside of corner 110b, with one side of its foot running along the bottom of the inside of tray side panel 106b and the other side of its foot running along the bottom of the inside of tray side panel 106c, foot 112c runs along the inside of corner 110c, with one side of its foot running along the bottom of the inside of tray side panel 106c and the other side of its foot running along the bottom of the inside of tray side panel 106d, and foot 112d runs along the inside of corner 110d, with one side of its foot running along the bottom of the inside of tray side panel 106d and the other side of its foot running along the bottom of the inside of tray side panel 106a).

Skeleton perimeter walls 116a/116b/116c/116d (barely visible in FIG. 1C) are also visible on the bottom or underside of the tray 102, and run along the top perimeter of the tray 102 (i.e., skeleton perimeter wall 116a runs along the top of side panel 106a, skeleton perimeter wall 116b runs along the top of side panel 106b, skeleton perimeter wall 116c runs along the top of side panel 106c, and skeleton perimeter wall 116d runs along the top of side panel 106d). The four skeleton perimeter walls 116a, 116b, 116c, 116d are connected to form a continuous rectangle along the top of the tray 102 (i.e., skeleton perimeter wall 116a connects to skeleton perimeter wall 116b and 116d, skeleton perimeter wall 116b connects to skeleton perimeter wall 116a and 116c, skeleton perimeter wall 116c connects to skeleton perimeter wall 116b and 116d and skeleton perimeter wall 116d connects to skeleton perimeter wall 116c and 116a).

FIGS. 1D and 1E depict side views of the bottom of the skeleton food container in accordance with an embodiment of the present disclosure. In FIG. 1D side panel 106a is shown. On the right side of side panel 106a is the corner 110a with a side seam 108a. On the left side of side panel 106a is the corner 110d with a side seam 108d. At the top of side panel 106a, perimeter walls 118a and 120a and their corresponding laterally extending surfaces 117a, 119a, 121a are shown with lid engaging portion 124a on top.

As previously discussed in FIG. 1A, a first laterally extending surface 117a abuts the entire length of skeleton perimeter wall 116a (not shown in FIG. 1D) at a right angle. Perimeter wall 118a abuts vertically laterally extending surface 117a to form a right angle with the laterally extending surface 117a. A second laterally extending surface 119a abuts perimeter wall 118 at a right angle. Perimeter wall 120a abuts vertically laterally extending surface 119a and forms a right angle with the laterally extending surface 119a. A third laterally extending surface 121a abuts perimeter wall 120a at a right angle. Around the perimeter of the third laterally extending surface 121a, is a lid-engaging portion 124a. The lid-engaging portion 124a, abuts the third laterally extending surface 121a and extends downward from it. The lid-engaging portion 124 creates a seal with a lid of the skeleton food container 100.

As noted above, the perimeter walls 116, 118, 120 and multiple laterally extending surfaces 117, 119, 121 abutting each other consecutively at right angles forms a stair step formation around the perimeter of the top of the tray 102. Although FIG. 1D shows three “steps”, (i.e., three laterally extending surfaces 117, 119, 121), any number can be used. As will be discussed in FIGS. 1F and 1G, in more detail with respect to the lids of the skeleton food container 100, this stair step formation on the top of the tray 102 along with the lid-engaging portion 124a may facilitate a liquid-tight seal when combined with a similar stair step formation and a lid-engaging portion in the lid of the skeleton food container 100.

As seen in FIGS. 1F and 1G, the lid 103 (which may be used to enclose the food-receiving volume of the tray 102, not shown) includes a horizontally extending top panel 138. The edges of the panel(s) of the lid may be surrounded by a skeleton structure, e.g., with the skeleton structure generally encircling a perimeter of the main horizontal/upper panel 138 of the lid. The skeleton structure of the lid may provide rigidity and may also define features to facilitate a liquid-proof interface with the tray 102, as will be discussed further below.

In some embodiments, the skeleton structure of the lid 103 protrudes vertically above the uppermost horizontal panel of the lid to form corner stops 134. Examples of these corner stops 134 are illustrated in FIGS. 1F and 1G. The corner stops 134 may generally enclose outer edges of the lower surface(s) of the tray 102 (not shown in FIGS. 1F or 1G), ensuring a secure horizontal retention of the tray 102 within the lid 103 when multiple food containers are stacked. The retention of a tray within the corner stops of a lid of a separate food container may reduce horizontal slipping of stacked containers, e.g., during handling or transportation. The formation of corner stops in the skeleton structure may also facilitate relatively larger features in comparison to those formed in fibrous materials. For example, protrusions in a resin or plastic material may be more reliably formed due to the decreased stretch of fibrous or paper-based materials. As seen in FIG. 1F, a protrusion height H above the horizontal surface of the fibrous panel 138 may be relatively greater than is possible for lids formed entirely of fibrous materials.

While the protrusions illustrated in the above examples are shown being formed in a lid, i.e., where the protrusions extend vertically upward, in other examples trays may have protrusions to facilitate stacking.

FIG. 1F shows a top perspective view of a skeleton food container lid 103 in accordance with an embodiment of the present disclosure. Components of the skeleton food container lid 103 can include four lid side panels 130, four corners 132, four lid laterally extending surfaces 140, four vertical lid perimeter walls 141, four channels 142, four bottom engaging portions 144, four lid corner stops 134, two side stops 136, one lid panel 138, and multiple stiffening ribs 146.

The lid of skeleton food container 103 as shown in FIG. 1F is rectangular in shape with four lid side panels 130a, 130b, 130c, and 130c. Each lid side panel 130a/130b/130c/130d is connected to two adjacent tray side panels via a lid corner 132a/132b/132c/132d (e.g., lid side panel 130a is connected to lid side panel 130b via lid corner 132a, lid side panel 130b is connected to lid side panel 130c via lid corner 132b, lid side panel 130c is connected to lid side panel 130d via lid corner 132c and lid side panel 130d is connected to lid side panel 130a via lid corner 132d).

At the top of each lid corner 132a/132b/132c/132d are lid corner stops 134a/ 134b/134c/134d (e.g., lid corner stop 134a is at the top of lid corner 132a, lid corner stop 134b is at the top of lid corner 132b, lid corner stop 134c is at the top of lid corner 134c, and lid corner stop 134d is at the top of lid corner 132d). The lid corner stops 134 can be made of a resin or plastic and can be incorporated into the skeleton structure of the lid 103. The lid corner stops 134a/134b/134c/134d extend along the top of their respective lid corner 132a/132b/132c/132d with one part along the top of each lid side panel 130a/ 130b/130c/130d (e.g., lid corner stop 134a follows along the top of lid corner 132a with one side along the top of lid side panel 130a and the other side along the top of lid panel 130b, lid corner stop 134b follows along the top of lid corner 132b with one side along the top of lid side panel 130b and the other side along the top of lid side panel 130c, lid corner stop 134c follows along the top of lid corner 132c with one side along the top of lid side panel 130c and the other side along the top of lid side panel 130d, lid corner stop 134d follows along the top of lid corner 132d with one side along the top of lid side panel 130d and the other side along the top of lid side panel 130a). As shown in FIG. 1F, the lid corner stops 134a, 134b, 134c, 134d are generally L-shaped following the shape of the lid corner 132 and protrude upwards. This protrusion enables the bottom of another similar skeleton food container bottom 102 to nest on top of a skeleton food container lid 103 and prevent movement. FIG. 1F further shows two lid side stops 136a and 136c. These lid side stops 136a, 136c are located on the top of their respective lid side panels 130a/130c equidistant from each corner (e.g., lid side stop 136a rests on the top of the lid side panel 130a and is equidistant from lid corner 132a and lid corner 132d, lid side stop 136c rests on top of the lid side panel 130c and is equidistant from lid corner 134b and lid corner 134c). Although FIG. 1F shows two lid side stops 136 in the center of their respective lid side panels 130, the lid 103 can have any number of side stops in any location along the top of the perimeter of the lid 103. As with the lid corner stops 134, the lid side stops 136 also protrude upwards and can assist with enabling the bottom of another similar skeleton food container bottom 102 to nest on top of a skeleton food container lid 103.

A lid laterally extending surface 140a/140b/140c/140d (140a and 140d not shown) extends along the bottom of each lid side panel 130a/130b/130c/130d respectively (e.g., lid laterally extending surface 140a extending along the bottom of lid side panel 130a, lid laterally extending surface 140b runs along the bottom of lid side panel 130b, lid laterally extending surface 140c runs along the bottom of lid side panel 130c, and lid laterally extending surface 140d runs along the bottom of lid side panel 130d). A lid vertical perimeter wall 141a/141b/141c/141d (141a and 141d not shown) generally extends along laterally extending surface 140a/140b/140c/140d and extends vertically from each lid laterally extending surface 140a/140b/140c/140d (e.g., lid vertical perimeter wall 141a runs along laterally extending surface 140a and extends vertically upwards from laterally extending surface 140a, lid vertical perimeter wall 141b runs along laterally extending surface 140b and extends vertically upwards from laterally extending surface 140b, lid vertical perimeter wall 141c runs along laterally extending surface 140c and extends vertically upwards from laterally extending surface 140c, and lid vertical perimeter wall 141d runs along laterally extending surface 140d and extends vertically upwards from laterally extending surface 140d). A channel 142a/142b/142c/142d (142c not shown) runs along the lid vertical perimeter wall 141a/ 141b/141c/141d and intersects the lid vertical perimeter wall 141a/141b/141c/141d horizontally (e.g., channel 142a runs laterally along lid vertical perimeter wall 141a and extends horizontally from lid vertical perimeter wall 141a, channel 142b runs laterally along lid vertical perimeter wall 141b and extends horizontally from lid vertical perimeter wall 141b, channel 142c runs laterally along lid vertical perimeter wall 141c and extends horizontally from lid vertical perimeter wall 141c, and channel 142d runs laterally along lid vertical perimeter wall 141d and extends horizontally from lid vertical perimeter wall 141d). A bottom engaging portion 144a/ 144b/144c/144d (144b and 144c not shown) runs along channel 142a/142b/142c/142d respectively and extends downward from channel 142a/142b/142c/142d, (i.e., bottom engaging portion 144a runs along channel 142a and extends downward from channel 142a, bottom engaging portion 144b runs along channel 142b and extends downward from channel 142b, bottom engaging portion 144c runs along channel 142c and extends downward from channel 142c, and bottom engaging portion 144d runs along channel 142d and extends downward from channel 142d). The bottom engaging portion 144 engages with the lid-engaging portion 124 of the tray 102 thereby “locking” the lid 103 in place with the tray 102. When the lid 103 is secured on the top of the tray 102, the top laterally extending surface 121a, 121b, 121c, 121d is flush with the channel 142a, 142b, 142c, 142d of the lid 103 (i.e., laterally extending surface 121a is flush against channel 142a, laterally extending surface 121b is flush against channel 142b, laterally extending surface 121c is flush against channel 142c, and laterally extending surface 121d is flush against channel 142d). This contact creates a better seal which prevents the contents of the container from spilling out.

The lid 103 also has several stiffening ribs 146. The stiffening ribs 146 or trusses provide support between the lid side panel 130, the lid laterally extending surface 142, and the vertical perimeter wall 141. More specifically, along each lid side panel 130a/130b/130c/130d are multiple stiffening ribs 146a/146b/146c/146d which are wedged between their respective lid side panel 130a/130b/130c/130d, their respective laterally extending surface 140a/140b/140c/140d and their respective perimeter wall 141a/141b/141c/141d (e.g., stiffening rib 146a1 is located along the left side of the lid side panel 130a and is wedged between lid side panel 130a, lid laterally extending surface 140a, and lid perimeter wall 141a, stiffening rib 146a2 is located along the middle of the lid side panel 130a and is wedged between the lid side panel 130a, lid laterally extending surface 140a and lid perimeter wall 141a, stiffening rib 146a3 is located along the right side of the lid side panel 130a and is wedged between lid side panel 130a, lid laterally extending surface 140a and lid perimeter wall 141a, stiffening rib 146b1 is located along the left side of the lid side panel 130b and is wedged between lid side panel 130b, laterally extending surface 140b and lid perimeter wall 141b, stiffening rib 146b2 is located along the right side of lid side panel 130b and is wedged between lid side panel 130b, laterally extending surface 140b and lid perimeter wall 141b, stiffening rib 146c1 is located along the left side of the lid side panel 130c and is wedged between lid side panel 130c, lid laterally extending surface 140c, and lid perimeter wall 141c, stiffening rib 146c2 is located along the middle of the lid side panel 130c and is wedged between the lid side panel 130c, lid laterally extending surface 140c and lid perimeter wall 141c, stiffening rib 146c3 is located along the right side of the lid side panel 130c and is wedged between lid side panel 130c, lid laterally extending surface 140c and lid perimeter wall 141c, stiffening rib 146d1 is located along the left side of the lid side panel 130d and is wedged between lid side panel 130d, laterally extending surface 140d and lid perimeter wall 141d, stiffening rib 146d2 is located along the right side of lid side panel 130d and is wedged between lid side panel 130d, laterally extending surface 140d and lid perimeter wall 141d). Although FIG. 1F shows 3 support structures 146, any number of support structures 146 can be used and be placed in any configuration along the lid side panels 130 and their respective laterally extending surfaces 142. The support structures 146 may generally increase overall stiffness of the lid 103, e.g., due to the increased stiffness of undulations of the support structures 146 in comparison to flat or straight panel structures.

The lid main panel 138 is generally contained within the perimeter of the lid 103. The lid main panel 138 can be formed of a fibrous material and is secured within the perimeter of the lid skeleton structure which can be made from a resin or plastic. The lid panel 138 is secured between the lid side panels 130a/130b/130c/130d, the lid corner stops 134a/134b/134c/134d and the side stops 136a/136c. (e.g., the lid panel 138 is flush on each side with its respective lid side panels 130, while the lid corner stops 134a, 134b, 134c, 134d and the side stops 136a, 136c are above the lid panel 138 thereby securing it in place).

FIG. 1G shows a bottom perspective view of a skeleton food container lid in accordance with an embodiment of the present disclosure. As in FIG. 1F, FIG. 1G shows the same components of the skeleton food container lid 103 but from a bottom perspective. These components can include four lid side panels 130, four corners 132, four lid laterally extending surfaces 140, four vertical lid perimeter walls 141, four channels 142, four bottom engaging portions 144, four lid corner stops 134, two side stops 136 and one lid panel 138.

FIG. 1H shows a cross-sectional side view of two trays 102a, 102b of a skeleton food container nested within each other in accordance with an embodiment of the present disclosure. As noted above, multiple laterally extending surfaces 117, 119, 121, two perimeter walls 118, 120, and a lid engaging portion 124 may be positioned at an upper portion or end of a side panel 106. In the illustrated example, tray 102a has a side panel 106.1. It extends at an angle from the tray bottom panel 104 (not shown). There is a first laterally extending surface 117.1 that extends from the side panel 106.1 horizontally and is parallel to the tray bottom panel 104 (not shown). A perimeter wall 118.1 extends upwardly at an angle from this laterally extending surface 117.1. A second laterally extending surface 119.1 extends from the perimeter wall 118.1 horizontally and is parallel to the tray bottom. A second perimeter wall 120.1 extends upwardly from the second laterally extending surface 119.1. A third laterally extending surface 121.1 extends horizontally from the second perimeter wall 119.1. Finally, there is a lid-engaging portion 124.1 that extends downwardly from the third laterally extending surface 121.1. Although the tray 102 shown in FIG. 1H shows two perimeter walls 118.1, 120.1 interspersed between three laterally extending surfaces 117.1, 119.1, 121.1, any number of perimeter walls and laterally extending surfaces can be used. As shown in FIG. 1H, the alternating use of perimeter walls 118.1, 120.1 with laterally extending surfaces 117.1, 119.1, 121.1 create a stair-step formation. These stair-steps can enable a lid 103 (not shown), e.g., having a corresponding stair-step structure or shape, to form a seal when secured on the tray 102. The laterally extending surfaces of both the bottom and the lid of the container may be flush against each other when the lid is secured, thereby creating a seal.

FIG. 1I shows stacked skeleton food containers in accordance with an embodiment of the present disclosure. In the bottom left of FIG. 1I a skeleton food container 100 is shown with its tray 102.1 and the lid 103.1. The lid 103.1 is secured on the top of the tray 102.1. On the lid 103.1 are four lid corner stops 134a, 134b, 134c, 134d and two side stops 136a, 136c. FIG. 1I shows a separate view of the skeleton food container 100 with another skeleton food container bottom 102.2 placed on top of the lid 103.1. The tray 102.2 is laterally retained within the four lid corner stops 134a, 134b, 134c (not shown), 134d and the two side stops 136a, 136c (136c not shown). The bottom rectangular perimeter of the second container tray102.2 fits snuggly within the rectangular perimeter created by the four lid corner stops and the two side stops of lid 103.1. This is possible because the sides of the container tray 102.1 extend upwardly from the bottom at a slight outward angle, thus making the perimeter at the bottom of the bottom 102.1 slightly smaller than the perimeter at the top of the of the bottom 102.1. The lid corner stops 134 and the side stops 136 protrude vertically above the lid panel 138, thus creating a frame to secure the next food container 102.2 on top. The retention of the tray within the corner stops of a lid 103 of a separate food container may reduce horizontal slipping of stacked containers.

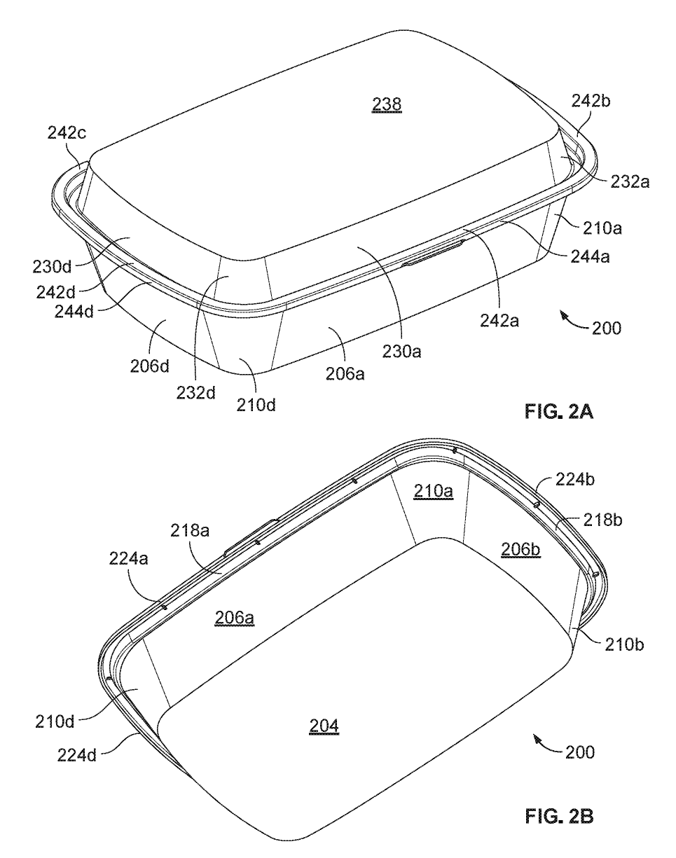

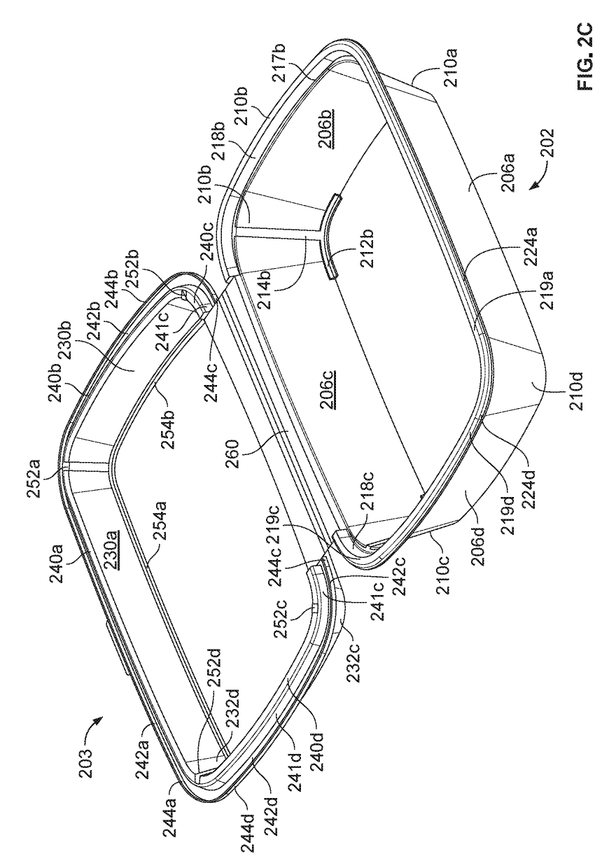

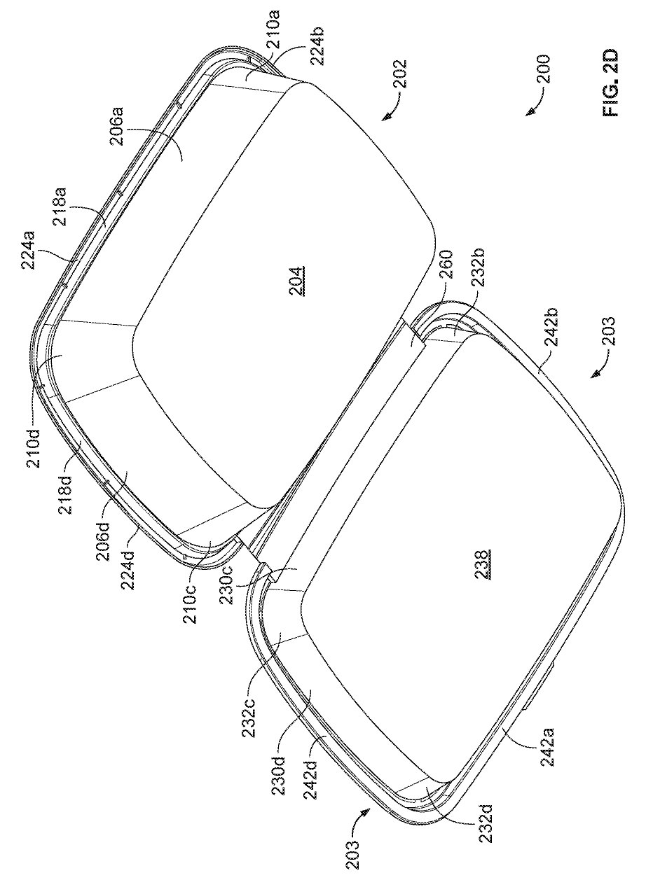

FIGS. 2A-2D illustrate an example food container 200 comprising a tray 202 and a lid 203 joined by a unitary hinge. FIG. 2C shows a top view of the skeleton food container 200 in an open configuration where the bottom/tray 202 and the top/lid 203 are connected by a hinge in accordance with another embodiment of the present disclosure. Although the tray 202 may include a variety of components, and one or more components may be added, removed, or modified in different embodiments. In the exemplary embodiment of FIG. 2C, components of the tray 202 can include a tray bottom panel 204, a plurality of tray side panels 206, a plurality of corners 210, a plurality of feet 212, a plurality of vertically extending posts 214, a perimeter wall 218, a plurality of laterally extending surfaces 217, 219, and a plurality of lid-engaging portions 224. It will be understood that the specific depicted relative dimensions and proportions illustrated in the drawings are exemplary only, and that the present disclosure applies to a variety of food container shapes. These shapes can include squares, rectangles, circles, ovals, polygons and irregular shapes, as may suit a particular end use application (e.g., customized shapes for particular food items). The sizes of the skeleton food container 200 can also vary from small enough to carry a single food serving to carrying multiple food portions for serving multiple people, and may include multiple internal sub-compartments and/or externally attached sub-compartments. The skeleton food container 200 can be made from various types of materials including paper, cardboard, molded fibers, pulp, light metal (e.g., light aluminum), plastics/polymers, bioplastics, styrofoam, and combinations of materials (e.g., a cardboard container having a plastic skeleton structure or having plastic “windows” on one or more sides). The skeleton container 200 material can include various treatments or coatings suitable for particular applications, such as to prevent leakage of liquid or viscous portions of the food items, to absorb moisture, to insulate to retain temperature, to provide structural integrity, etc.

The bottom of skeleton food container 202 as shown in FIG. 2C is rectangular in shape with four tray side panels 206a/206b/206c/206c. Each tray side panel 206a/206b/206c/206d is connected to two adjacent tray side panels via a corresponding corners 210a/210b/210c/210d similar to food container 100 described above. Each side of the tray bottom panel 204 is connected to a lower end of a respective tray side panel 206a/206b/206c/ to form an enclosed container. The tray bottom panel 204 and the tray side panels 206 can be formed of a single monolithic piece or otherwise continuous material where the side panels 206 are created by folding each side panel upwards. Alternatively, the tray bottom panel 204 can be a separate piece where it is then attached to the tray side panels 206 to form an enclosed container. The tray bottom panel 204 can be attached to the side panels 206 by various adhesives or any other methods that are convenient.

In FIG. 2C, there is a skeleton structure 222 visible within the interior of the tray 202. The skeleton structure 222 includes four feet 212a/212b,/212c/212d, four vertically extending posts 214a/214b/214c/214d (only foot 212b and vertically extending post 214b are visible in FIG. 2C), and multiple laterally extending surfaces, 217a/217b/217c/217d, 219a/219b/219c/219d, 4 perimeter walls 218a/218b/218c/218d and 4 lid engaging portions 224a/224b/224c/224d (only portions of the skeleton structure is visible in FIG. 2C). The skeleton structure 222 can be connected to form one piece or multiple pieces.

The top of the tray 202 also has four perimeter skeleton walls 218a/218b/218c/218d and their corresponding skeleton laterally extending surfaces 217 (217a/217b/217c/217d) and 219 (219a, 219b, 219c, 219d). Skeleton laterally extending surfaces 217a/217b/217c/217d extend about the top perimeter of the tray 102 and abut the top of their corresponding side panel 206a/206b/206c/206d at a right angle (e.g., skeleton laterally extending surface 217a runs along the top perimeter of side panel 206a and abuts the side panel 206a at a right angle, skeleton laterally extending surface 217b runs along the top perimeter of side panel 206b and abuts the side panel 206b at a right angle, skeleton laterally extending surface 217c runs along the top perimeter of side panel 206c and abuts the side panel 206c at a right angle, skeleton laterally extending surface 217d runs along the top perimeter of side panel 206d and abuts the side panel 206d at a right angle). Perimeter walls 218a/218b/218c/218d each abut a corresponding skeleton laterally extending surface 217a/217b/217c/217d, = forming a right angle Second skeleton laterally extending surfaces 219a/219b/219c/219d, each abut a respective corresponding perimeter wall 218a/218b/218c/218d at a right. Around the perimeter of the skeleton laterally extending surface 219a/219b/219c/219d is a lid-engaging portion 224a/224b/224c/224d. The lid-engaging portions 224a/224b/224c/ 224d (224b and 224c are not visible in FIG. 2C) abut the skeleton laterally extending surface 219a/219b/219c/219d and extend downward therefrom. The lid-engaging portion 224 may create a seal with lid 203 of the skeleton food container 200 when the lid 203 is closed upon the tray 202.

FIG. 2C shows the bottom of the skeleton container 202 connected to the skeleton container lid 203 via a hinge 260, with the lid 203 in an open position, e.g., for consuming food from the tray 202. The hinge 260 can be part of a continuous piece of material that makes the bottom and the lid a single, monolithic piece, or the hinge can be its own separate piece which is joined or adhered to both the bottom of the skeleton container 202 and the skeleton lid 203. The hinge 260 may also have a perforation in its center that allows for an easy removal of the skeleton container lid 203 from the bottom of the skeleton container 202, e.g., to facilitate tearing the lid 203 off from the tray 202.

A skeleton container lid 203 is attached to hinge 260. FIG. 2C shows an upper perspective view of the food container 200 in the open position, while FIG. 2D shows a bottom perspective view of the food container 200 with the lid 203 open. FIG. 2C shows four lid side panels 230, four lid corners 232, four lid laterally extending surfaces 240, four vertical lid perimeter walls 241, four channels 242, four bottom engaging portions 244, and one lid panel 238.

The lid of skeleton food container 203 as shown in FIG. 2C is rectangular in shape with four lid side panels 230a, 230b, 230c, and 230d. Each lid side panel 230a/230b/230c/230d is connected to two adjacent tray side panels via a lid corner 232a/232b/232c/232d.

From the perspective of FIG. 2C, a lid laterally extending surface 240a/240b/ 240c/240d extends along the top of each lid side panel 230a/230b/230c/230d respectively and intersects the corresponding lid side panels 230a/230b/230c/230d at a right angle. There is a lid vertical perimeter wall 241a/241b/241c/241d that extends along laterally extending surface 240a/240b/240c/240d and extends vertically downward (from the perspective of 2C) from each lid laterally extending surface 240a/ 240b/240c/. A lid channel 242a/242b/242c/ 242d extends along the lid vertical perimeter wall 241a/241b/241c/241d and intersects the lid vertical perimeter wall 241a, 241b, 241c, 241d horizontally at the bottom from the perspective of FIG. 2C. A tray engaging portion 244a/244b/244c/244d runs along channel 242a, 242b, 242c, 242d respectively and extends upwards from channel 242a, 242b, 242c, 242d,. The tray engaging portion 244 engages with the lid-engaging portion 224 of the tray 202 thereby “locking” the lid 203 in place with the tray 202. When the lid 203 is secured on the top of the tray 202, the top laterally extending surface 219a, 219b, 219c, 2219d is flush with the channel 242a, 242b, 242c, 242d of the lid 103 (i.e., laterally extending surface 219a is flush against channel 242a, laterally extending surface 219b is flush against channel 242b, laterally extending surface 219c is flush against channel 242c, and laterally extending surface 119d is flush against channel 242d). This contact of adjacent promotes sealing and reduces the likelihood of contents of the container from spilling out through an interface between the tray 202 and lid 203.

FIG. 2C shows a lid main panel 238 which is secured within the perimeter of the lid 203. The lid main panel can be made from a fibrous material and is secured within the perimeter of the lid skeleton structure which can be made from a resin or plastic. The lid panel 238 is secured between the lid side panels 230a, 230b, 230c, 230d (i.e., the lid panel 238 is flush on each side with its respective lid side panels). The lid 203 of FIG. 2C further shows a skeleton structure 250 within the lid 203. This skeleton structure 250 includes four lid bottom skeleton perimeters 254, four lid vertically extending posts 252, four lid vertical perimeter walls 241, four lid channels 242, and four bottom engaging portions 244.

In FIG. 2C, lid skeleton structure 250 is visible in the interior of the bottom of the skeleton food container lid 203. The skeleton structure has four lid bottom skeleton perimeters 254a/254b/254c/254d, four lid vertically extending posts 252a/252b/ 252c/252d (only lid bottom skeleton perimeters 254a and 254b are visible in FIG. 2C), four lid vertical perimeter walls 241a/241b/241c/241d, four lid channels 242a/242b/ 242c/242d and four bottom engaging portions 244a/244b/244c/244d (only portions of the lid skeleton structure 250 is visible in FIG. 2C). The lid skeleton structure 250 can be formed in a single piece, e.g., by being overmolded onto the panels as wil be described further below, or may be formed in multiple pieces that are joined or connected together.

As shown in FIG. 2C, the lid bottom skeleton perimeter 254a/254b/254c/254d of the lid skeleton structure 250 extends along the inside of the bottom of each respective inside lid side panel 230a/230b/230c/230d (i.e., lid bottom skeleton perimeter 254a runs along the bottom of the inside of lid side panel 230a, lid bottom skeleton perimeter 254b runs along the bottom of the inside of lid side panel 230b, lid bottom skeleton perimeter 254c runs along the bottom of the inside of lid side panel 230c, and lid bottom skeleton perimeter 254d runs along the bottom of the inside of lid side panel 230d). The lid vertically extending posts 252a/252b/252c/252d intersect perpendicularly at the junction of their two respective lid bottom skeleton perimeters 254a/254b/254c/254d and extend upwards along the inside of the respective corners 232a/232b/232c/232d ending at the junction of the two corresponding skeleton lid vertical perimeter walls 241a/241b/241c/241d.

The lid vertical perimeter walls 241a/241b/241c/241d are connected to their corresponding lid channels 242a/242b/242c/242d and corresponding bottom engaging portions 244a/244b/244c/244d.

As noted above, the example food container 200 employs a unitary hinge 260 joining the tray 202 and lid 203. The hinge 260 provides a clamshell configuration that facilitates “opening” the lid (FIGS. 2C and 2D) and closing the lid (FIGS. 2A and 2B). The hinge 260 may be formed from the same second material as the skeleton structure or, as illustrated in FIGS. 2A-2C, may be formed of the fibrous material. This hinge generally simplifies the design, enabling the container to be opened and closed easily while maintaining a secure seal when closed. In the illustrated example, a fibrous material sheet may be cut to define the main horizontal surfaces/panels of the lid and tray, as well as panels defining the hinge in between. Further, the sheet may include side panels that may be folded to provide the overall shape of the lid and tray. Subsequently, a skeleton structure for the tray may be formed, and edges of the panels may be adhered to the skeleton structure to define a final shape of the tray and lid.

In the lower perspective view of FIG. 2D the bottom of the skeleton container 202 is visible, and is shown having four side panels 206, four corners 210, four perimeter walls 218, and four lid engaging portions 224, and as such not all components of the bottom of the skeleton food container are visible in FIG. 2D. Similarly, some parts of the bottom or underside of the skeleton container lid 203 are shown in FIG. 2D such as the lid panel 238, lid corner 232, lid side panel 230, and lid channel 242. FIG. 2D also shows the underside of the hinge 260 which connects the skeleton container bottom 202 with the skeleton container lid 203.

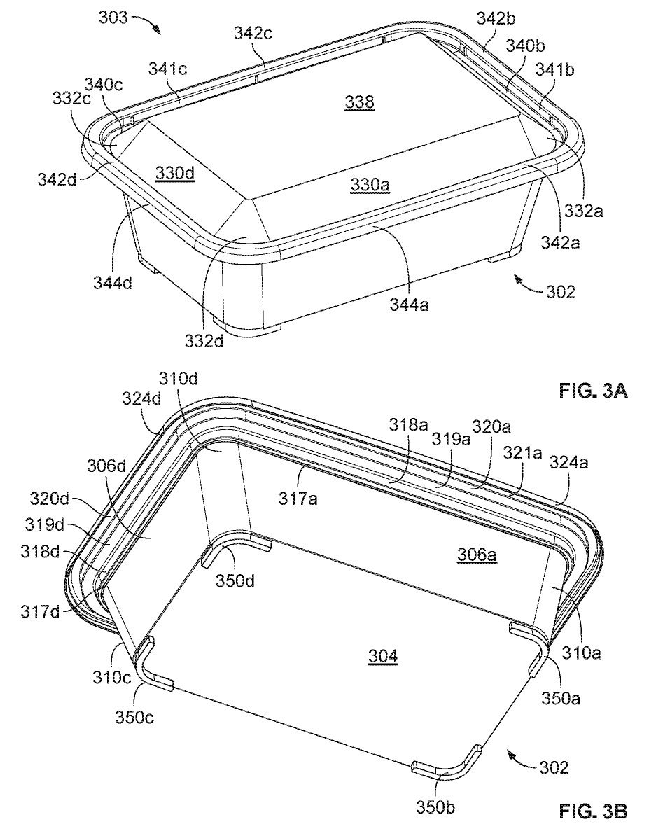

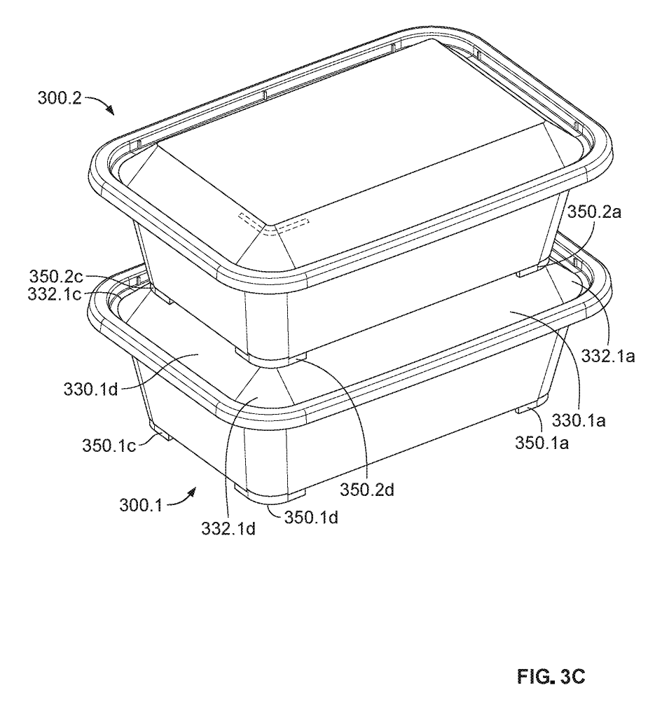

Referring now to FIGS. 3A and 3B, a food container 300 is illustrated having a tray 302 and lid 304 that are separate parts, with corner stops 350 provided on a lower or bottom surface of the tray 302. More specifically, FIG. 3A illustrates a top view of the assembled lid 303 and tray 302, while FIG. 3B shows a bottom view thereof. Although the tray 302 may include a variety of components, and one or more components may be added, removed, or modified in different embodiments, in the embodiment of FIG. 3B, components of the bottom of a skeleton food container 302 can include a tray bottom panel 304, a plurality of tray side panels 306, a plurality of corners 310, a plurality of perimeter walls 318, 320, a plurality of laterally extending surfaces 317, 319, 321, a plurality of lid-engaging portions324, and a plurality of bottom corner stops 350. It will be understood that the specific depicted relative dimensions and proportions are exemplary only, and that the present disclosure applies to a variety of food container shapes. These shapes can include squares, rectangles, circles, ovals, polygons and irregular shapes, as may suit a particular end use application (e.g., customized shapes for particular food items). The sizes of the skeleton food container 300 can also vary from small enough to carry a single food serving to carrying multiple food portions for serving multiple people, and may include multiple internal sub-compartments and/or externally attached sub-compartments. The skeleton food container 300 can be made from similar types of materials as set forth above regarding food containers 100 and 200, i.e., including paper, cardboard, molded fibers, pulp, light metal (e.g., light aluminum), plastics/polymers, bioplastics, styrofoam, and combinations of materials (e.g., a cardboard container having a plastic skeleton structure or having plastic “windows” on one or more sides). The skeleton container 300 material can include various treatments or coatings suitable for particular applications, such as to prevent leakage of liquid or viscous portions of the food items, to absorb moisture, to insulate to retain temperature, to provide structural integrity, etc.

The bottom of skeleton food container 302 as shown in FIG. 3B is rectangular in shape with four tray side panels 306a/306b/306c/306c (Side panels 306b and 306c not shown). Each tray side panel 306a/306b/306c/306d is connected to two adjacent corners 310a/310b/310c/310d (e.g., tray side panel 306a is connected to corner 310a on one side and 310d on the other side, tray side panel 306b (not shown) is connected to corner 310a on one side and 310c (not shown) on the other side, tray side panel 106c (not shown) is connected to corner 310b on one side and corner 310c on the other side, tray side panel 310d is connected to corner 310c on one side and corner 310d on the other side). Tray bottom panel 304 is connected to the bottom of each tray side panel 306a, 306b, 306c, 306d at their respective sides to form an enclosed container. The tray bottom panel 304 and the tray side panels 306 can be one continuous material where the side panels 306 are created by folding each side panel upwards or the tray bottom panel 304 can be a separate piece where it is then attached to the tray side panels 306 to form an enclosed container. The tray bottom panel 304 may be formed in a monolithic single piece with the side panels 306 (e.g., with the side panels 206 being folded upward) or may be separate piece joined by an adhesive or the like. At each corner of the tray 302 are bottom corner stops 350a/350b/350c/350d protruding from the bottom of the tray 302. The bottom corner stops 350 may each be formed integrally with the skeleton structure, protruding through the bottom panel 304 of the tray 302. These bottom corner stops 350 follow along the bottom of each corner starting on the bottom of one side panel 306 going around the corner and ending on the other side panel 306 (e.g., bottom corner stop 350a extends along a portion of the bottom of side panel 306a following the contour of corner 350a to the bottom of side panel 306b). These corner stops 350 protrude vertically downward from the bottom of the bottom of the skeleton container 302 and can be used to facilitate stacking with other containers as shown in FIG. 3C. These corner stops 350 may be made from a resin or plastic as the skeleton structure previously discussed in other embodiments.

The top of the bottom of the skeleton food container has perimeter walls 318 (318a, 318b, 318c, and 318d) and 320 (320a, 320b, 320c, 320d) and their corresponding laterally extending surfaces 317 (317a, 317b, 317c, 317d), 319 (319a, 319b, 319c, 319d), and 321 (321a, 321b, 321c, 321d). In FIG. 3B, only perimeter walls and laterally extending surfaces on side a and d are shown. Laterally extending surface 317a/ 317b/317c/317d, abuts the top of their respective corresponding bottom side panel 306a/306b/306c/306d at a right angle (e.g., laterally extending surface 317a abuts the top of the entire length of bottom side panel 306a at a right angle, laterally extending surface 317b abuts the top of the entire length of bottom side panel 306b at a right angle, laterally extending surface 317c abuts the top of the entire length of bottom side panel 306c at a right angle, and laterally extending surface 317d abuts the top of the entire length of bottom side panel 306d at a right angle). Perimeter walls 318a/318b/318c/318d abut vertically laterally extending surface 317a/317b/317c/317d and form a right angle with the laterally extending surface 317a/317b/317c/317d, respectively (e.g., perimeter wall 318a abuts vertically to laterally extending surface 317a forming a right angle, etc.). A second laterally extending surface 319a/319b/319c/319d, abuts a corresponding perimeter wall 318a/318b/318c/318d at a right angle (e.g., laterally extending surface 319a abuts the entire length of perimeter wall 318a at a right angle, etc.). Perimeter walls 320a/320b/320c/320d abut vertically laterally extending surface 319a/ 319b/319c/319d and form a right angle with the laterally extending surface 319a/319b/ 319c/319d (e.g., perimeter wall 320a abuts vertically to laterally extending surface 319a forming a right angle, etc.). A third laterally extending surface 321a/ 321b/321c/321d, abuts their respective corresponding perimeter wall 320a/320b/320c/ 320d at a right angle (e.g., laterally extending surface 321a abuts the entire length of perimeter wall 320a at a right angle, etc.). Around the perimeter of the third laterally extending surface 321a, 321b, 321c, 321d is a lid-engaging portion 324a, 324b, 324c, 324d. The lid-engaging portion 324a, 324b, 324c, 324d (324b and 324c are not visible in FIG. 3B) abuts the third laterally extending surface 321a, 321b, 321c, 321d and extends downward therefrom (e.g.., lid-engaging portion 324a abuts laterally extending surface 321a and extends downward from laterally extending surface 321a). The lid-engaging portion 324 may create a seal with a lid 303 of the skeleton food container 300.

The combination of multiple perimeter walls 318, 320 and multiple laterally extending surfaces 317, 319, 321 abutting each other consecutively at right angles forms a stair step formation around the perimeter of the top of the tray 302. Although FIG. 3B shows three “steps”, i.e., three laterally extending surfaces 317, 319, 321, any number can be used. As was previously discussed, this stair step formation on the top of the tray 302 along with the lid-engaging portion 324 enhances a liquid-tight seal when combined with a similar stair step formation and a lid-engaging portion in the lid of the skeleton food container 300.

FIG. 3A shows a top view of a skeleton food container bottom and lid in a closed configuration where the bottom has bottom corner stops in accordance with another embodiment of the present disclosure. In addition to the bottom of the skeleton container 302 as already described above in FIG. 3B, FIG. 3A shows the lid 303 secured on top of the tray 302.

The lid of the skeleton container 303 is rectangular in shape with four lid side panels 330a, 330b, 330c, and 330c. Each lid side panel 330a/330b/330c/330d is connected to two adjacent tray side panels via a lid corner 332a/332b/332c/332d (i.e., lid side panel 330a is connected to lid side panel 330b via lid corner 332a, lid side panel 330b is connected to lid side panel 330c via lid corner 332b, lid side panel 330c is connected to lid side panel 330d via lid corner 332c and lid side panel 330d is connected to lid side panel 330a via lid corner 332d).

A lid laterally extending surface 340a/340b/340/340d extends along the bottom of each lid side panel 330a/330b/330c/330d respectively and extends horizontally from their respective lid side panel 330a/330b/330c/330d (e.g., lid laterally extending surface 340a runs along the bottom of lid side panel 330a and extends horizontally from lid side panel 330a, etc.). A lid vertical perimeter wall 341a/341b/341c/341d extends along their respective laterally extending surface 340a/340b/340c/340d and extends vertically from each lid laterally extending surface 340a/340b/340c/340d (e.g., lid vertical perimeter wall 341a runs along laterally extending surface 340a and extends vertically from laterally extending surface 340aetc.). A channel 342a/342b/342c/ 342d extends along the lid vertical perimeter wall 341a,/341/341c/341d and intersects the lid vertical perimeter wall 341a/341b/341c/341d horizontally (e.g., channel 342a runs laterally along lid vertical perimeter wall 341a and extends horizontally from lid vertical perimeter wall 341a, channel 342b runs laterally along lid vertical perimeter wall 341b and extends horizontally from lid vertical perimeter wall 341b, channel 342c runs laterally along lid vertical perimeter wall 341c and extends horizontally from lid vertical perimeter wall 341c, and channel 342d runs laterally along lid vertical perimeter wall 341d and extends horizontally from lid vertical perimeter wall 341d). A bottom engaging portion 344a/344b/344c/344d extends along channel 342a/342b/342c/342d respectively and extends downward from channel 342a/342b/342c/342d, (e.g., bottom engaging portion 344a runs along channel 342a and extends downward from channel 342a, etc.). The bottom engaging portion 344 engages with the lid-engaging portion 324 of the tray 302 thereby “locking” the lid 303 in place with the tray 302. When the lid 303 is secured on the top of the tray 302, the bottom laterally extending surface 321a/321b/321c/321d may be flush with the channel 342a/ 342b/342c/342d of the lid 303 (e.g., laterally extending surface 321a is flush against channel 342aetc.). This contact may enhance a seal between the lid 303 and tray 302, further preventing contents of the container from spilling out.

FIG. 3A further shows a lid main panel 338 which is positioned within the perimeter of the lid 303. The lid main panel can be made from a fibrous material and may be centrally positioned within a perimeter of the lid skeleton structure which can be made from a resin or plastic. The lid panel 338 is secured within the perimeter created by the lid side panels 330a, 330b, 330c, 330d. The lid panel 338 and the lid side panels 330 can be a single, monolithic piece of material where the lid 303 is folded, or the lid panel 338 can be a separate piece from the lid side panels 330. When the lid panel 338 is a separate piece from the lid side panels 330, the lid panel 338 may be attached to the lid side panels by an adhesive, bonding, or any other manner that is convenient.

FIG. 3C shows two skeleton food containers stacked on top of one another with a bottom and a lid in a closed configuration where the bottom corner stops 350 may facilitate stacking in accordance with another embodiment of the present disclosure. FIG. 3C shows two skeleton food containers 300.1 and 300.2, each of which have all the features already described of container 300 in FIGS. 3A and 3B. With respect to FIG. 3C, skeleton food container 300.2 is stacked on top of skeleton food container 300.1. The bottom corner stops 350.1a/350.1b (not shown)/350.1c/350.1d protrude from a lower end of the skeleton food container 300.1. The bottom corner stops 350.2a/350.2b (not shown)/350.2c/250.2d of skeleton food container 300.2 are shown stacked on top of skeleton food container 300.1. The protrusions of each bottom corner stop 350.2a/350.2b/350.2c/350.2d extend downward toward the lid of skeleton tray container 300.1, engaging with the top of each corner of the lid 332,1a/332.1b/332.1c/332.1d (e.g., bottom corner stop 350.2a extends downward and engages with lid corner 332.1a, etc.).

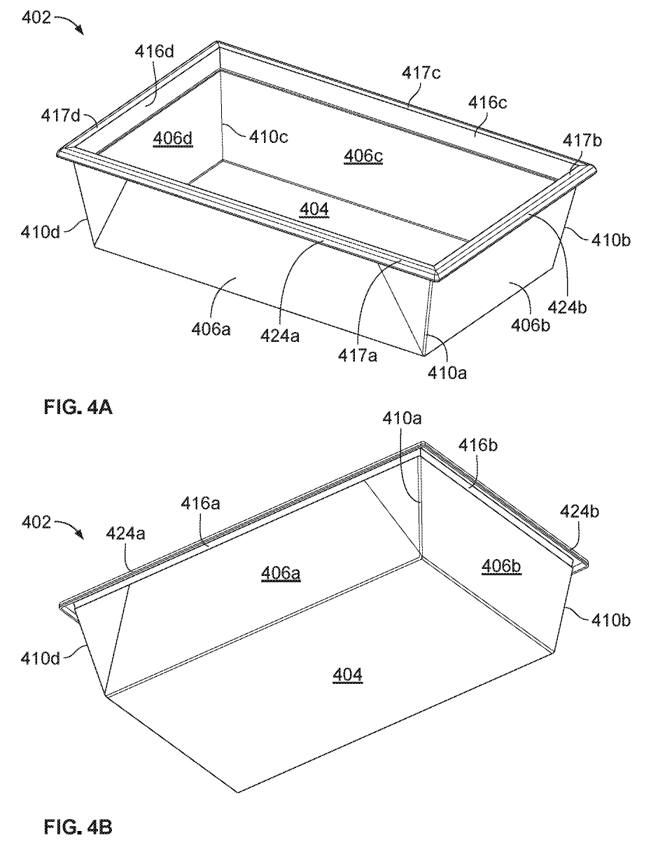

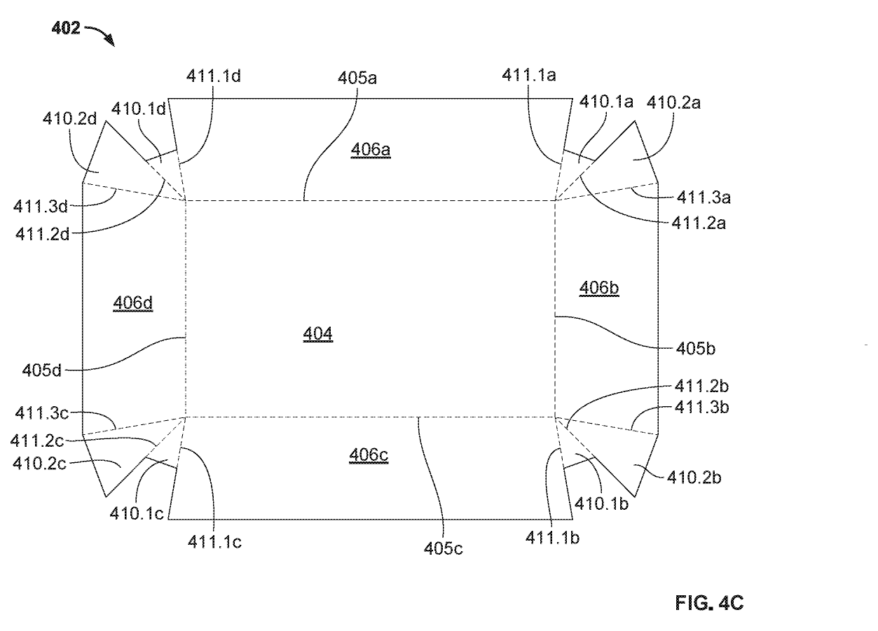

In some example approaches, a skeleton tray may be formed on folded portions of the tray, e.g., in a fibrous/paper-based portion of the tray. For example, as illustrated in FIGS. 4A, 4B, and 4C, a skeleton structure of a tray formed of a polymer/resin material generally includes a lid-engaging portion extending about an uppermost perimeter of the tray.

FIG. 4A shows a top perspective view of a bottom of a skeleton food container in accordance with another embodiment of the present disclosure. Components of the bottom of a skeleton food container 402 can include a tray bottom panel 404, a plurality of tray side panels 406, a plurality of corners 410, a skeleton perimeter wall 416, a laterally extending surface 417, and a plurality of lid-engaging portions 424. It will be understood that the specific depicted relative dimensions and proportions are exemplary only, and that the present disclosure applies to a variety of food container shapes. These shapes can include squares, rectangles, circles, ovals, polygons and irregular shapes, as may suit a particular end use application (e.g., customized shapes for particular food items). The sizes of the skeleton food container 400 can also vary from small enough to carry a single food serving to carrying multiple food portions for serving multiple people, and may include multiple internal sub-compartments and/or externally attached sub-compartments. The skeleton food container 400 can be made from various types of materials including paper, cardboard, molded fibers, pulp, light metal (e.g., light aluminum), plastics/polymers, bioplastics, styrofoam, and combinations of materials (e.g., a cardboard container having a plastic skeleton structure or having plastic “windows” on one or more sides). The skeleton container 400 material can include various treatments or coatings suitable for particular applications, such as to prevent leakage of liquid or viscous portions of the food items, to absorb moisture, to insulate to retain temperature, to provide structural integrity, etc.

The bottom of skeleton food container 402 as shown in FIG. 4A is rectangular in shape with four tray side panels 406a/406b/406c/406d. Each tray side panel 406a/406b/406c/406d is connected to two corresponding corners 410a/410b/410c/410d (e.g., tray side panel 406a is connected to tray side panel 406b via corner 410aetc.). Tray bottom panel 404 is connected to the bottom of each tray side panel 406a/406b/406c/406d at their respective sides to form an enclosed container. In the embodiment shown in FIGS. 4A-4C the tray bottom panel 404 and the tray side panels 406 are a single monolithic piece or continuous material where the side panels 406 are created by folding each side panel upwards.

In the example shown in FIGS. 4A-4C, a skeleton structure extends about a top perimeter of the tray 402. It should be understood that a lid (not shown) may also be provided for enclosing the tray 402, in similar manner as lid 303 with respect to tray 302, lid 203 with respect to tray 202, and lid 103 with respect to tray 102. In the illustrated example four skeleton perimeter walls 416a/416b/416c/416d (416a and 416b not shown) are flush against the top edge of each of their respective side panels 406a/406b/406c/406d (e.g., skeleton perimeter wall 416a is flush along the top edge of side panel 406aetc.). Laterally extending surface 417a/ 417b, 417c, 417d, is flush against and abuts a corresponding skeleton perimeter wall 416a/416b/416c/416d at a right angle (e.g., laterally extending surface 417a is flush against and abuts skeleton perimeter wall 416a at a right angle, etc.). Around the perimeter of the laterally extending surface 417a/417b/417c/417d is a lid-engaging portion 424a/424b/424c/424d. The lid-engaging portion 424a/424b/424c/424d (424d and 424d are not visible in FIG. 4A) abuts the laterally extending surface 417a/417b/417c/417d and extends downward therefrom (e.g., lid-engaging portion 424a abuts laterally extending surface 417a and extends downward from laterally extending surface 417aetc.). The lid-engaging portion 424 creates a seal with a lid (not shown) of the skeleton food container 400. The skeleton perimeter walls 416, laterally extending surfaces 417 and lid engaging portion 424 make up the skeleton structure of the skeleton container as shown in FIGS. 4A-4C.

FIG. 4B shows a bottom perspective view of a bottom of the tray 402. FIG. 4B shows parts of the bottom of the skeleton container 402 with four side panels 406, four corner 410, four skeleton perimeter walls 416, four laterally extending surfaces 417, and four lid engaging portions 424.

The skeleton structure of the tray 402 may be molded upon a fibrous or paper-based lower portion of the tray 402. The fibrous/lower portion(s), as illustrated, may include tray webs or folds near corner region of the tray, e.g., as may result from folding over portions of tray side and/or bottom panels to form the generally quadrangular shape of the fibrous/paper-based portion of the tray. Accordingly, the skeleton structure of the example illustrated in FIGS. 4A-4C is located exclusively in the upper/perimeter portion that engages the lid (i.e., there are no posts or feet extending into the lower region of the tray, as in other examples described herein). Accordingly, the entire bottom portion of the tray may be formed of a fibrous material.

FIG. 4C shows a top view of a flattened blank for the bottom of the skeleton food container shown in FIGS. 4A and 4B prior to assembly in accordance with another embodiment of the present disclosure. FIG. 4C shows one continuous piece of material where it is folded in certain areas to create the side panels 406a/406b/406c/406d and their respective corners 410a/410b/410c/410d (corners 410 are labelled into two parts shown as 410.1 and 410.2). Four side panels 406a/406b/406c/406d surround the perimeter of the bottom panel 404 with a corresponding side panel fold line 405a/405b/405c/405d in between the side panel 406 and the bottom panel (e.g., side panel fold line 405a is between 406a and bottom panel 404, side panel fold line 405b is between 406b and bottom panel 404, side panel fold line 405c is between 406c and bottom panel 404, and side panel fold line 405d is between side panel 406d and bottom panel 404). There are four two-part corner panels 410 which are connected between each side panel 406 (e.g., there are corner panels 410.1a and 410.2a located between side panels 406a and 406b, corner panels 410.1b and 410.2b located between side panels 406b and 406c, corner panels 410.1c and 410.2c located between side panels 406c and 406d, and corner panels 410.1d and 410.2d located between side panels 406d and 406a). On the edge of each corner panels are their corresponding fold lines 411 (e.g., fold line 411.1a is located between side panel 406a and corner panel 410.1a., fold line 411.2a is located between corner panel 410.1a and corner panel 410.2a, fold line 411.3a is located between corner panel 410.2a and side panel 406b, fold line 411.1b is located between side panel 406c and corner panel 410.1b., fold line 411.2b is located between corner panel 410.1b and corner panel 410.2b, fold line 411.3b is located between corner panel 410.2b and side panel 406b, fold line 411.1c is located between side panel 406c and corner panel 410.1c., fold line 411.2c is located between corner panel 410.1c and corner panel 410.2c, fold line 411.3c is located between corner panel 410.2c and side panel 406d, fold line 411.1d is located between side panel 406a and corner panel 410.1d., fold line 411.2d is located between corner panel 410.1d and corner panel 410.2d, fold line 411.3d is located between corner panel 410.2d and side panel 406d).

To form the food container as shown in FIGS. 4A-4C, the blank illustrated in FIG. 4C may be initially flat, and may then be folded upward and inward among the various fold lines 405, 411. The four side panels 406a/406b/406c/406d are folded upward along their respective fold lines 405a/405b/405c/405d (e.g., side panel 406a is folded upward along fold line 405a, side panel 406b is folded upward along fold line 405b, side panel 406c is folded upward along fold line 405c, and side panel 406d is folded upward along fold line 405d). As the side panels 406a/406b/406c/406d are folded up, their respective corner panels and fold lines are also folded to form the corner of the container 400 (e.g., when side panels 406a and 406b fold up, corner panel 410.1a and 410.2a bend at fold lines 411.1a., 411.2a, and 411.3a making a corner 410a, when side panels 406b and 406c fold up, corner panel 410.1b and 410.2b bend at fold lines 411.1b., 411.2b, and 411.3b making a corner 410b, when side panels 406c and 406d fold up, corner panel 410.1c and 410.2c bend at fold lines 411.1c., 411.2c, and 411.3c making a corner 410c, and when side panels 406d and 406a fold up, corner panel 410.1d and 410.2d bend at fold lines 411.1d., 411.2d, and 411.3d to form corner 410d). These corners 410a/410b/410c/410d create double-folded corners (or also may be referred to as webbed corners and generally provide a fully leak-proof design for the skeleton container bottom 402 through the use of double folded fibrous material.

The double-folded corners may be formed with crease lines added to the die cut piece of fibrous material illustrated in FIG. 4C (where the entire outer perimeter indicates cut lines, with all interior non-dimensioning lines indicating fold lines). Accordingly, the example illustrated in FIGS. 4A and 4C may be formed by (1) cutting the outer perimeter indicated in FIG. 4C, and (2) subsequently folding along the fold lines indicated in FIG. 4C. The cut piece may, in at least some examples, be folded in a mold using guides as the die-cut fibrous material blank is inserted to the mold. Additionally, a resin/polymer material may subsequently be injected around the fibrous material to form the skeleton structure.

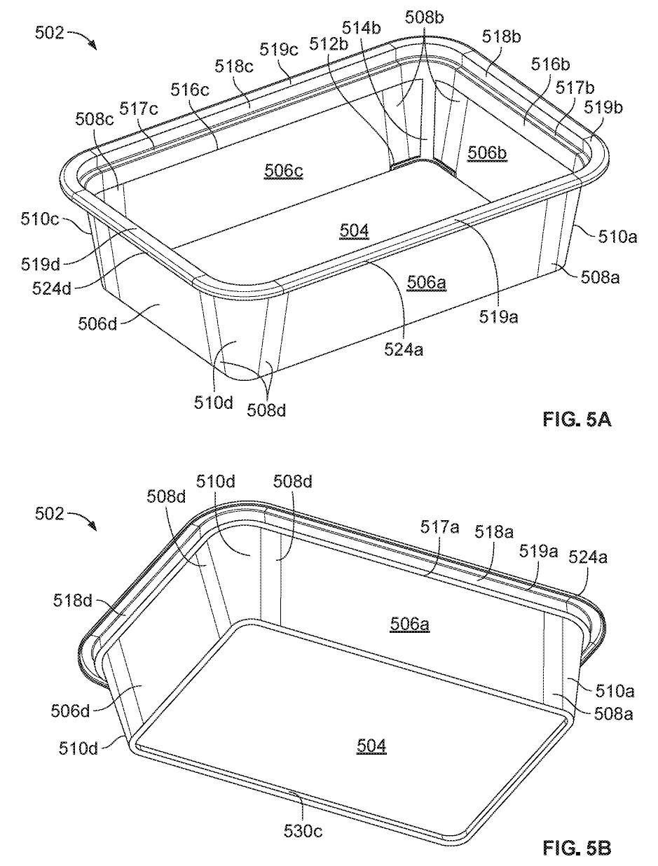

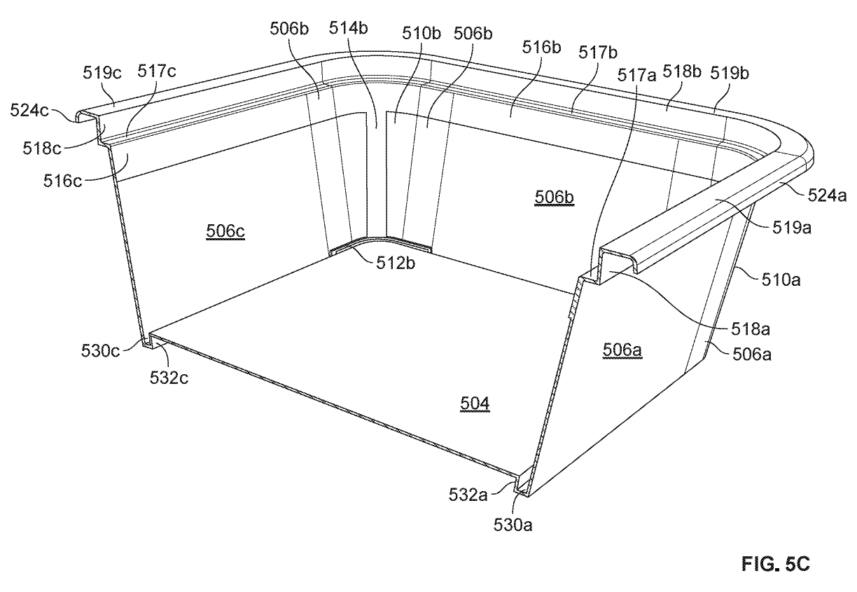

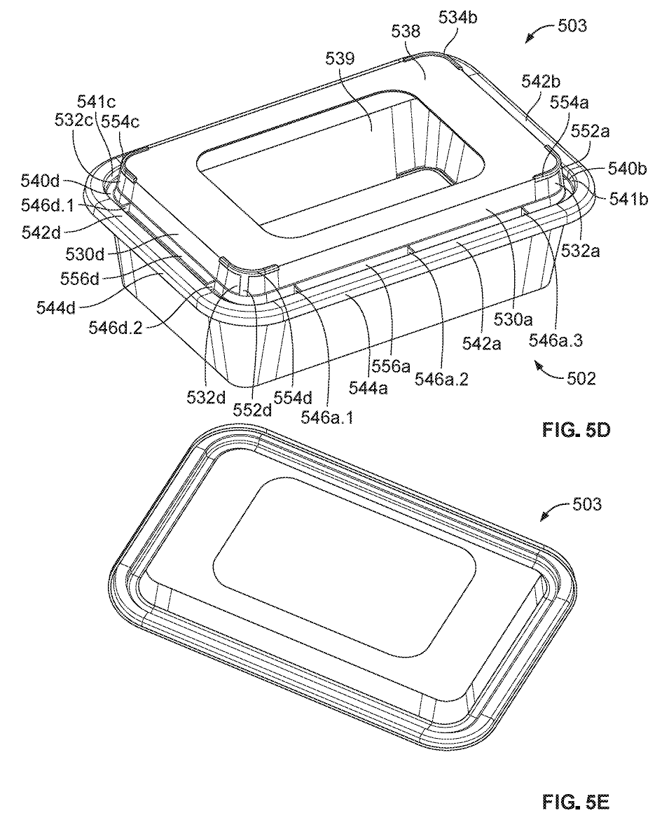

FIGS. 5A-5C show a food container 500 having a channel around a perimeter of a tray 502 of the container, in accordance with another embodiment of the present disclosure. FIG. 5A shows a top perspective view of a tray 502. Although the tray 502 may include a variety of components, and one or more components may be added, removed, or modified in different embodiments, in the embodiment of FIG. 5A, components of the tray 502 can include a tray bottom panel 504, a plurality of tray side panels 506, a plurality of tray side panel seams 508, a plurality of corners 510, a plurality of feet 512, a plurality of vertically extending posts 514, a skeleton perimeter wall 516, a plurality of perimeter walls 518, a plurality of laterally extending surfaces 517, 519, a plurality of lid-engaging portions 524, and a perimeter channel (not shown in FIG. 5A). It will be understood that the specific depicted relative dimensions and proportions are exemplary only, and that the present disclosure applies to a variety of food container shapes. These shapes can include squares, rectangles, circles, ovals, polygons and irregular shapes, as may suit a particular end use application (e.g., customized shapes for particular food items). The sizes of the skeleton food container 500 can also vary from small enough to carry a single food serving to carrying multiple food portions for serving multiple people, and may include multiple internal sub-compartments and/or externally attached sub-compartments. The skeleton food container 500 can be made from various types of materials including paper, cardboard, molded fibers, pulp, light metal (e.g., light aluminum), plastics/polymers, bioplastics, styrofoam, and combinations of materials (e.g., a cardboard container having a plastic skeleton structure or having plastic “windows” on one or more sides). The skeleton container 500 material can include various treatments or coatings suitable for particular applications, such as to prevent leakage of liquid or viscous portions of the food items, to absorb moisture, to insulate to retain temperature, to provide structural integrity, etc.

The tray 502 as shown in FIG. 5A is rectangular in shape with four tray side panels 506a/506b/506c/506d. Each tray side panel 506a/506b/506c/506d is connected to two adjacent tray side panels via a tray side panel seam 508a/508b/508c/508d which forms the corresponding corners 510a/510b/510c/510d (e.g., tray side panel 506a is connected to tray side panel 506b via tray side panel seam 508a and forming corner 510a, tray side panel 506a is connected to tray side panel 506d via tray side panel seam 508d and forming corner 510d, etc.). Tray bottom panel 504 is connected to the bottom of each tray side panel 506a, 506b, 506c, 506d at their respective sides to form an enclosed container. The tray bottom panel 504 and the tray side panels 506 can be a single monolithic piece or continuous material where the side panels 506 are created by folding each side panel upwards. Alternatively, the tray bottom panel 504 can be a separate piece where it is then attached to the tray side panels 506 to form an enclosed container, e.g., by bonding, adhesive or the like.

In FIG. 5A, a skeleton structure 522 is visible within the interior of the tray 502 and extends to the top of the tray 502. The skeleton structure has four feet 512a, 512b, 512c, 512d, four vertically extending posts 514a, 514b, 514c, 514d (only foot 512b and vertically extending post 514b are visible in FIG. 5A), four skeleton perimeter walls 516a, 516b, 516c, and 516d (only skeleton perimeter walls 516b and 516c are visible in FIG. 5A), laterally extending surface 517a, 517b, 517c, 517d (only 517b and 517c are shown), vertical perimeter wall 518a, 518b, 518c, 518d (only 518b and 518c are shown), laterally extending surface 519a, 519b, 519c, 519d, and lid engaging portion 524a, 524b, 524c, 524d. The skeleton structure 522 can be a single monolithic piece, e.g., formed in a molding process, or may be multiple piece connected or secured together.

Each foot 512a/512b/512c/512d is connected to its respective vertically extending post 514a/514b/514c/514d (e.g., foot 512b is connected to vertically extending post 514b, etc. (In FIG. 5A, only foot 512b and vertically extending post 514b is shown). Each vertically extending post 514a/514b/514c/514d is connected at the intersection of two skeleton perimeter walls 516a/516b/516c/516d (e.g., vertically extending post 514a is connected at the intersection of skeleton perimeter walls 516a and 516b, vertically extending post 514b is connected at the intersection of skeleton perimeter walls 516b and 516c, etc.).

As shown in FIG. 5A, the feet 512a/ 512b/512c/512d of the skeleton structure 522 each extend along the inside of the bottom of each respective inside corner 510/510b/510c/510d, with one side of each foot extending along the bottom of their intersecting side panels 506a/506b/506c/506d (e.g., foot 512a runs along the inside of corner 510a, with one side of its foot running along the bottom of the inside of tray side panel 506a and the other side of its foot running along the bottom of the inside of tray side panel 506b, foot 512b runs along the inside of corner 510b, with one side of its foot running along the bottom of the inside of tray side panel 506b and the other side of its foot running along the bottom of the inside of tray side panel 506c, etc.). In another embodiment, the foot 512a/512b/512c/512d run along the inside of the bottom of each corner 510a/510b/510c/510d to the bottom of the perimeter channel 530a/530b/530c/530d with one side of each foot running along the bottom of the intersection of the perimeter channels 530a/530b/530c/530d. The vertically extending posts 514a, 514b, 514c, 514d intersect their respective feet 512a, 512b, 512c,512d perpendicularly and extend upwards along the inside of the respective corners 510a, 510b, 510c, 510d ending at the junction of the two corresponding skeleton perimeter walls 516a, 516b, 516c, 516d (e.g., vertically extending post 514a perpendicularly intersects foot 512a and then extends upwards along the inside of corner 510a and ends at the junction of skeleton perimeter wall 516a and 516b, etc.).

The skeleton structure 522 of the tray 502 shown in FIG. 5A also includes four perimeter skeleton walls 516a/516b/516c/516d and perimeter wall 518a/518b/518c,518d, their corresponding laterally extending surfaces 517a/517b/517c/517d, and 519a/519b/519c.519d, and four lid engaging portions 524a/ 524b/524c/524d.. In FIG. 5A, skeleton perimeter walls 516b, 516c, perimeter walls 518b, 518c, laterally extending surfaces 517b, 517c, 519a, 519b, 519c, 519d and lid engaging portions 524a and 524d are shown. Skeleton perimeter walls 516a/516b/516c/516d extend about the top perimeter of the tray 502. A first laterally extending surface 517a/517b/517c/517d, abuts the top of their respective corresponding skeleton perimeter wall 516a/516b/516c/516d at a right angle (e.g., laterally extending surface 517a abuts the top of the entire length of skeleton perimeter wall 516a at a right angle, laterally extending surface 517b abuts the top of the entire length of skeleton perimeter wall 516b at a right angle, laterally extending surface 517c abuts the top of the entire length of skeleton perimeter wall 516c at a right angle and laterally extending surface 517d abuts the top of the entire length of skeleton perimeter wall 516d at a right angle). Perimeter walls 518a/518b/518c/518d abut vertically laterally extending surface 517a/517b/517c/517d and form a right angle with the laterally extending surface 517a/517b/517c/517d (e.g., perimeter wall 518a abuts vertically to laterally extending surface 517a forming a right angle, perimeter wall 518b abuts vertically to laterally extending surface 517b forming a right angle, etc.). A second laterally extending surface 519a/519b/519c/519d abuts their respective corresponding perimeter wall 518a/518b/518c/518d at a right angle (e.g., laterally extending surface 519a abuts the entire length of perimeter wall 518a at a right angle, laterally extending surface 519b abuts the entire length of perimeter wall 518b at a right angle, laterally extending surface 519c abuts the entire length of perimeter wall 518c at a right angle and laterally extending surface 519d abuts the entire length of perimeter wall 518d at a right angle). Around the perimeter of the second laterally extending surface 519a/519b/519c/519d is a lid-engaging portion 524a/524b/524c/524d. The lid-engaging portions 524a/524b/524c/524d (524b and 524c are not visible in FIG. 5A) each abut their respective second laterally extending surface 519a/519b/519c/519d and extend downward from it (e.g., lid-engaging portion 524a abuts laterally extending surface 519a and extends downward from laterally extending surface 519a, lid-engaging portion 524b abuts laterally extending surface 519b and extends downward from laterally extending surface 519b, etc.). The lid-engaging portion 524 may generally promote a seal with a lid (not shown in FIGS. 5A-5C) of the skeleton food container 500.

The combination of multiple perimeter walls 516, 518, and multiple laterally extending surfaces 517, 519, abutting each other consecutively at right angles forms a stair step formation around the perimeter of the top of the tray 502. Although FIG. 5A shows two “steps”, i.e., two laterally extending surfaces 517, 519), any number can be used.

FIG. 5B shows a bottom perspective view of a skeleton food container bottom of FIG. 5A in accordance with another embodiment of the present disclosure. Although the tray 502 may include a variety of components, and one or more components may be added, removed, or modified in different embodiments, in the embodiment of FIG. 5B, components of the tray 502 can include a tray bottom panel 504, a plurality of tray side panels 506, a plurality of side panel seams 508, a plurality of corners 510, a plurality of perimeter walls 518, a plurality of laterally extending surfaces 517, 519, and a plurality of lid-engaging portions 524.

The bottom of skeleton food container 502 as shown in FIG. 5B is rectangular in shape with four tray side panels 506a/506b/506c,506c (Side panels 506b and 506c not shown). Each tray side panel 506a/506b/506c/506d is connected to two adjacent tray side panels via a tray side panel seam 508a/508b/508c/508d which forms the corresponding corners 510a/510b/510c/510d (e.g., tray side panel 506a is connected to tray side panel 506b via tray side panel seam 508a and forming corner 510a, tray side panel 506a is connected to tray side panel 506d via tray side panel seam 508d and forming corner 510d, etc.). Tray bottom panel 504 is connected to the bottom of each tray side panel 506a/506b/506c/506d at their respective sides to form an enclosed container. The tray bottom panel 504 and the tray side panels 506 can be a single monolithic piece or a continuous material where the side panels 506 are created by folding each side panel upwards. Alternatively, the tray bottom panel 504 can be a separate piece that is joined with the tray side panels 506, e.g., by an adhesive bonding or the likes.

FIG. 5B show the upper portion of the tray 502 has perimeter walls 518 (518a, 518b, 518c, and 518d), their corresponding laterally extending surfaces 517 (517a, 517b, 517c, 517d) and 519 (519a, 519b, 519c, 519d), and lid engaging portions 524 (524a, 524b, 524c, 524d) In FIG. 5B, only perimeter walls and laterally extending surfaces on sides a and d are shown. Laterally extending surface 517a/ 517b, 517c, 517d each abut the top of their respective corresponding bottom side panel 506a/506b/506c/506d at a right angle (e.g., laterally extending surface 517a abuts the top of the entire length of the top of bottom side panel 506a at a right angle, laterally extending surface 517b abuts the top of the entire length of the top of bottom side panel 506b at a right angle, etc.). Perimeter walls 518a/518b/518c/518d vertically abut laterally extending surface 517a/ 517b/517c/517d and form a right angle with the laterally extending surface 517a/517b/ 517c/517d (e.g., perimeter wall 518a vertically abuts laterally extending surface 517a forming a right angle, perimeter wall 518b vertically abuts laterally extending surface 517b forming a right angle, etc.). A second laterally extending surface 519a/519b/519c/519d abuts their respective corresponding perimeter wall 518a/518b/ 518c/518d at a right angle (e.g., laterally extending surface 519a abuts the entire length of perimeter wall 518a at a right angle, laterally extending surface 519b abuts the entire length of perimeter wall 518b at a right angle, etc.). Around the perimeter of the laterally extending surface 519a/519b/519c/519d is a lid-engaging portion 524a/524b/524c/524d. The lid-engaging portion 524a/524/524c/524d (524b and 524c are not visible in FIG. 5B) abuts laterally extending surface 519a/519b/519c/519d and extends downward from it (e.g., lid-engaging portion 524a abuts laterally extending surface 519a and extends downward from laterally extending surface 519a, lid-engaging portion 524b abuts laterally extending surface 519b and extends downward from laterally extending surface 519betc.). The lid-engaging portion 524 generally promotes a seal between the tray 502 and a lid (not shown in FIGS. 5A-5C) of the skeleton food container 500.

FIG. 5C shows a cross-section view of one side of the skeleton bottom container shown in FIGS. 5A and 5B where a perimeter channel is shown in accordance with another embodiment of the present disclosure. FIG. 5C shows three side panels 506a/506b/506c, side panel seam 506a/506b506c, corners 510a and 510b, a bottom panel 504, three skeleton perimeter walls 516a/516b/516c (516a not shown), laterally extending surfaces 517a/517b/517c, three perimeter walls 518a/518b/518c, three laterally extending surfaces 519a/519b/519c, lid engaging portion 524a/524c, foot 512b, vertically extending post 514b, perimeter channel 530a/530b/530c, and channel vertical wall 532a/532c. FIG. 5C shows in greater detail the perimeter channel 530 of embodiments 5A-5D. In FIG. 5C, a laterally extending surface or channel 530a/530b/530c/530d runs along the bottom perimeter of their respective side panels 506a/506b/506c/506d and abuts their respective side panels 506a/506b/506c/506d so that the channel is about parallel and below bottom panel 504 (e.g., perimeter channel 530a runs along the bottom of side panel 506a and abuts side panel 506a where it is about parallel and below bottom panel 504, perimeter channel 530b runs along the bottom of side panel 506b and abuts side panel 506b where it is about parallel and below bottom panel 504, etc.). This channel 530a/530b/530c/530d is positioned lower than the bottom panel 504. A channel vertical wall 532a/532b/532c/532d perpendicularly intersects its respective channel 530a/530b/530c/530d at the bottom and perpendicularly intersects the bottom panel 504 at the top (e.g., the bottom of channel vertical wall 532a runs along and intersects channel 530a perpendicularly and then extends upwards and runs along and intersects perpendicularly its corresponding side of the bottom panel 504, the bottom of channel vertical wall 532b runs along and intersects channel 530b perpendicularly and then extends upwards and runs along and intersects perpendicularly its corresponding side of the bottom panel 504, the bottom of channel vertical wall 532c runs along and intersects channel 530c perpendicularly and then extends upwards and runs along and intersects perpendicularly its corresponding side of the bottom panel 504, the bottom of channel vertical wall 532d runs along and intersects channel 530d perpendicularly and then extends upwards and runs along and intersects perpendicularly its corresponding side of the bottom panel 504).

Accordingly, tray 502 may include a channel extending around an outer perimeter of a bottom panel. As this channel is lower than the bottom panel 504 of the tray 502, this channel may generally collect and manage liquids that may drain from food items placed in the tray, e.g., grease, oils, or the like. The channel may minimize risk of leakage and help maintain cleanliness during use. For example, as illustrated in FIGS. 5A-5E, a tray and lid assembly for a food container is illustrated where a channel is formed about a perimeter of a lowermost panel of the tray, i.e., in the fibrous or paper-based portion of the tray. As seen in FIG. 5C, which is a section view of the tray, the perimeter channel may define a relatively lower channel portion surrounding a lower panel of the tray, such that grease, oils, or other liquids may tend to accumulate in the channel (rather than remaining on the lowermost panel, remaining entrained with food during consumption). Furthermore, to the extent surface tension of the liquids may tend to keep liquids in the channels, such liquids may be drained from food items in the tray.

In the example illustrated in FIGS. 5A-5E, the lid 503 includes a skeleton structure comprising a tray-engaging portion where an upward-facing channel includes one or more stiffening ribs. The ribs may increase lateral stiffness of the skeleton structure and portions of the lid that are retained to the tray, thereby allowing greater retention forces. The ribs may add rigidity to a locking lip of the lid. Additionally, the ribs may also control stacking of multiple pieces together for shipping of finished products. For example, the ribs may provide a hard stop when nesting multiple lids together, making a vertical distance between each lid consistent and minimizing or eliminating loads otherwise placed on the locking rib in the channel (which would risk being damaged in transit).

FIG. 5D shows a top perspective of a lid 503 of a skeleton food container secured on the tray 502 of FIGS. 5A-5C.

The lid 503 as shown in FIG. 5D is rectangular in shape with four lid side panels 530a/530b/530c/530d (530b and 530c not shown). Each lid side panel 530a/530b/530c/530d is connected to two adjacent tray side panels via a lid corner 532a/532b/532c/532d (532b not shown) (e.g., lid side panel 530a is connected to lid side panel 530b via lid corner 532a, lid side panel 530b is connected to lid side panel 530c via lid corner 532b, lid side panel 530c is connected to lid side panel 530d via lid corner 532c and lid side panel 530d is connected to lid side panel 530a via lid corner 532d).

At the top of each lid corner 532a/532b/532c/532d are lid feet 554a/554b/ 554c/554d (i.e., lid foot 554a is at the top of lid corner 532a, lid foot 554b is at the top of lid corner 532b, etc.). The lid feet 554 can be made of a resin or plastic and are part of the skeleton structure of the lid 503. The lid feet 554a/554b/554c/554d follow along the top of their respective lid corner 532a/532b/532c/532d with one part along the top of each lid side panel 530a/530b/530c/530d (e.g., lid foot 554a extends along the top of lid corner 532a with one side along the top of lid side panel 530a and the other side along the top of lid panel 530b, lid foot 554b follows along the top of lid corner 532b with one side along the top of lid side panel 530b and the other side along the top of lid side panel 530c, etc.). As shown in FIG. 5D, the lid feet 554a/554b/554c554d are generally L-shaped, following the shape of their respective lid corner 532a/532b/532d/532d. Lid vertically extending posts 552a/552b/552c/552d (552b and 552c not shown) are connected to their respective lid feet 554a/554b/554c/554d in the center and extend vertically downwards along their respective corners 532a/532b/532c/532d (e.g., lid vertically extending post 552a is connected to the center of lid foot 554a and extends vertically downwards along corner 532a, lid vertically extending post 552b is connected to the center of lid foot 554b and extends vertically downwards along corner 532betc.). Lid skeleton perimeter wall 556a/556b/556c/556d (556b and 556c not shown) extends along the bottom their respective lid side panels 530a/530b/530c/530d from lid corner to lid corner 532a/532b/532c/532d and connects with the respective lid vertically extending posts 552a/552b/552c/552d on each side (e.g., lid skeleton perimeter wall 556a runs along the bottom of lid side panel 530a from lid corner 532d to lid corner 532a and connects with lid vertically extending post 552d at lid corner 532d and lid vertically extending post 552a at lid corner 532a, lid skeleton perimeter wall 556b runs along the bottom of lid side panel 530b from lid corner 532a to lid corner 532b and connects with lid vertically extending post 552a at lid corner 532a and lid vertically extending post 552b at lid corner 532b, etc.).

A lid laterally extending surface 540a/540b/540c/540d runs along the bottom of each lid skeleton perimeter wall 556a/556b/556c/556d respectively and perpendicularly abuts the lid skeleton perimeter wall 556a/556b/556c/556d (i.e., lid laterally extending surface 540a runs along and perpendicularly abuts lid skeleton perimeter wall 556a, lid laterally extending surface 540b runs along and perpendicularly abuts lid skeleton perimeter wall 556b, lid laterally extending surface 540c runs along and perpendicularly abuts lid skeleton perimeter wall 556c, and lid laterally extending surface 540d runs along and perpendicularly abuts lid skeleton perimeter wall 556d). There is a lid vertical perimeter wall 541a/541b/541c/541d that runs along laterally extending surface 540a/540b/540c/540d and extends vertically upwards from each lid laterally extending surface 540a/540b/540c/540d (e.g., lid vertical perimeter wall 541a runs along laterally extending surface 540a and extends vertically upwards from laterally extending surface 540a, lid vertical perimeter wall 541b runs along laterally extending surface 540b and extends vertically upwards from laterally extending surface 540b, etc.). A channel 542a/542b/542c/542d runs along the top of the lid vertical perimeter wall 541a/541b/541c/541d and horizontally intersects the lid vertical perimeter wall 541a/541b/541c/541d horizontally (e.g., channel 542a runs laterally along the top of lid vertical perimeter wall 541a and horizontally intersects lid vertical perimeter wall 541a, channel 542b runs laterally along the top of lid vertical perimeter wall 541b and horizontally intersects lid vertical perimeter wall 541b, etc.). A bottom engaging portion 544a, 544b, 544c, 544d runs along channel 542a, 542b, 542c, 542d respectively and extends downward from channel 542a/542b/542c/542d (e.g., bottom engaging portion 544a runs along channel 542a and extends downward from channel 542a, etc.). The bottom/tray engaging portion 544 engages with the lid-engaging portion 524 of the tray 502 thereby “locking” the lid 503 in place with the tray 502. When the lid 503 is secured on the top of the tray 502, the top laterally extending surface 519a, 519b, 519c, 519d may be flush with the channel 542a, 542b, 542c, 542d of the lid 503 (i.e., laterally extending surface 519a is flush against channel 542a, laterally extending surface 519b is flush against channel 542b, etc.). This contact promotes sealing and reduces spilling or prevents the contents of the container from spilling out.

The lid 503 also has a plurality of stiffening ribs 546. These stiffening ribs 546 or trusses may increase lateral stiffness and strength of the skeleton structure and portions of the lid 503 and provide addition support between the lid side panels 530, lid skeleton perimeter walls 556 and the lid laterally extending surface 540. More specifically, along each lid skeleton perimeter wall 556a/556b/556c/556d are multiple stiffening ribs 546a/546b/546c/546d which are wedged between the lid skeleton perimeter walls 556a/556b/556c/556d, their respective laterally extending surface 540a, 540b, 540c, 540d and their respective lid vertical perimeter wall 541a/541b/541c/541d (e.g., stiffening rib 546a1 is located along the left side of the lid skeleton perimeter wall 556a and is wedged between lid skeleton perimeter wall 556a, lid laterally extending surface 540a, and lid vertical perimeter wall 541a, stiffening rib 546a2 is located along the middle of the lid skeleton perimeter wall 556a and is wedged between the lid skeleton perimeter wall 541a, lid laterally extending surface 540a, and lid vertical perimeter wall 541a, etc.).

Although FIG. 5D shows 3 stiffening ribs 546 on the longer sides of the tray 502, and two stiffening ribs 546 on the short sides, any number of stiffening ribs 546 can be used and be placed in any configuration along the lid skeleton perimeter walls 556.

FIG. 5D further shows a lid main panel 538 which is secured within the perimeter of the lid 503 with the lid feet 554 surrounding each corner of the lid panel 538. The lid panel 538 is secured between the lid side panels 530a, 530b, 530c, 530d and the lid feet 554a/554b/554c/554d. (e.g., the lid panel 538 is flush on each side with its respective lid side panels, while the lid feet 554 surround each corner of the lid panel 538). In the center of the lid panel 538 there is a transparent portion 539. Example food containers may also incorporate transparency or translucency into one or more panels, enabling users to visually inspect the contents without opening the lid. This may be particularly advantageous for retail or display purposes, allowing customers to view the food while maintaining its freshness and hygiene. For example, as illustrated in the lid of FIGS. 5D and 5E, the lid upper panel may have a cutout in which a transparent or translucent panel is positioned, allowing visibility into the food container when the lid is closed upon the tray. In an example, a transparent panel is applied to a flat-cut fibrous portion of the lid during an additional process, e.g., prior to forming/molding of the lid skeleton structure.

FIG. 5E shows a bottom perspective of the lid 503 shown in FIG. 5D in accordance with another embodiment of the present disclosure. FIG. 5E shows the transparent cut out 539 located within the lid panel 538 from the bottom perspective.

Additionally, example food containers may employ micro-perforations in fibrous materials to promote venting. For example, a horizontal upper panel of a lid may include micro-perforations, allowing the container to vent excess moisture or steam while preserving the seal between the lid and the tray. For example, allowing venting of the steam via the micro-perforations may prevent pressure buildup within the food container that might reduce security of a seal between the lid and tray. Accordingly, micro-perforations may be particularly useful for packaging hot or freshly cooked food items to the extent it may help maintain the quality and texture of the food by preventing leaks and condensation buildup.

Example methods of making food containers as described herein may generally facilitate a food container designed to securely house food items while ensuring structural integrity and liquid-proof functionality. As noted above, example containers may be composed of a tray and a lid, both constructed using a combination of materials, e.g., a fibrous panel(s) joined together by a resin-based skeleton structure. The method ensures precise assembly and durability, optimizing the container for practical use in food storage and transportation.

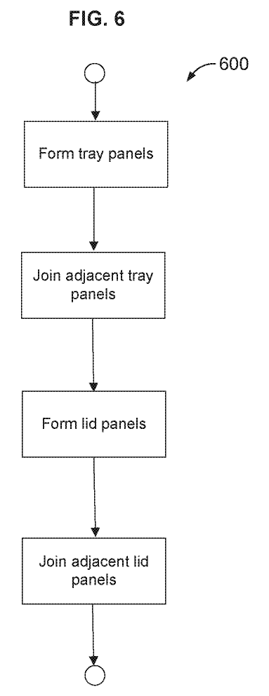

Referring now to FIG. 6, an example process 600 of forming a food container is illustrated and described in further detail. Process 600 may begin at block 602, where a tray, e.g., tray 102, 202, 302, 402, or 502, may be formed to define a volume for receiving and holding a food item. To construct the tray, a plurality of tray panels may be provided. These panels may be composed of a fibrous material, such as cardboard or other paper-based substrates, which may be chosen for their lightweight properties, environmental sustainability, and ease of manufacturing. Each tray panel may be cut and shaped to predetermined dimensions, ensuring a snug fit when assembled. The tray panels, as described above in the foregoing examples, may include a horizontally extending bottom panel and a plurality of vertically extending side panels that define the tray's walls and open top. Example approaches may employ a single sheet including a horizontally extending lower panel and one or more side panels, which may be formed by folding the side panels relative to the lower/horizontal panel.

Proceeding to block 604, one or more adjacent edges of the tray panels may then be joined using a tray skeleton structure, e.g., formed from a resin material such as plastic. The skeleton structure, as noted above, serves as a relatively rigid framework that connects the panels at their edges and forms robust and durable corners. This step may employ a molding or extruding process with respect to the resin material, thereby creating corner reinforcements and linear connectors that align and secure the panels. Further, the molding process may adhere adjacent edges of panels together. The tray skeleton structure ensures the assembled tray is durable, resistant to deformation, and capable of withstanding the weight and moisture of food items. By combining the flexibility and sustainability of fibrous materials with the strength of resin, the resulting tray achieves an optimal balance of performance and eco-friendliness. Process 600 may then proceed to block 606.

At block 606, process 600 may form a lid, which is generally configured to enclose the tray's volume along a liquid-proof interface. Similar to the tray, the lid may be constructed by providing a plurality of lid panels made of the same fibrous material. The lid panels may include a horizontally extending top panel and a plurality of side panels that extend downward to overlap with the upper edges of the tray when the lid is closed upon the tray. These panels may be cut and shaped to fit the tray’s dimensions, ensuring a secure seal when the lid is applied. To the extent a lid includes multiple panels, a single sheet of the fibrous material may be cut with side panels of the lid being folded relative to a main/upper horizontally extending surface. Process 600 may then proceed to block 608.

At block 608, adjacent edges of the lid panels may be joined using a lid skeleton structure, which may also be formed from a resin material, as with the skeleton structure of the tray. In an example, the lid skeleton structure is molded or extruded to form connectors and corner reinforcements, similar to those used for the tray. These connectors may align and secure the lid panels, forming robust corners that enhance rigidity of the lid and ensure the lid retains its shape during handling and storage. The lid skeleton structure may also include additional features, such as protrusions that extend above the top panel to form corner stops, as noted above. These corner stops may interact with the edges of the tray to prevent horizontal movement and ensure a stable stacking of adjacent food containers. Process 600 may then terminate.

In summary, example food containers may employ a hybrid or multi-material construction to provide a highly functional, durable, and eco-conscious solution for food transportation, consumption, and/or storage. The hybrid construction combines the sustainability of fibrous materials with the strength of resin-based skeleton structures, providing a leak-proof, stackable, and visually appealing design. The inclusion of features such as corner stops, liquid channels, venting perforations, and a unitary hinge in some example approaches may enhance its usability, making it an ideal choice for a wide range of food packaging applications. Similarly, in example methods a combination of materials may facilitate achieving desired properties of the food container. The fibrous material used for the panels provides a sustainable and lightweight option, reducing environmental impact while offering sufficient strength for normal use. Meanwhile, the resin material used for the skeleton structures adds structural integrity and durability, ensuring the container can withstand repeated use and environmental stresses.

The precise joining of panels and skeleton structures ensures the container is both functional and reliable. The liquid-proof interface between the lid and tray is a critical feature, achieved by aligning the panels and skeleton structures with tight tolerances during assembly. This interface prevents leakage and maintains the hygiene of the food stored inside, making the container suitable for a wide range of food items, including those with high moisture content.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A food container, comprising:
a tray defining a volume for receiving a food item, the tray including:
a plurality of tray panels formed of a first material; and
a tray skeleton structure joining adjacent edges of the panels to form one or more corners, the skeleton structure formed of a second material different from the first material; and
a lid configured to enclose the volume of the tray along a liquid-proof interface between the lid and tray, the lid including:
one or more lid panels formed of the first material; and
a lid skeleton structure forming a perimeter of the lid, the lid skeleton structure formed of a second material different from the first material.

2. The food container of claim 1, wherein the first material is a fibrous material.

3. The food container of claim 2, wherein the fibrous material is a cardboard material.

4. The food container of claim 1, wherein the first material is a paper-based material.

5. The food container of claim 1, wherein the second material is a resin material.

6. The food container of claim 5, wherein the resin material is a plastic.

7. The food container of claim 1, wherein the skeleton structure of the tray defines four corners of the tray; and wherein the plurality of panels of the tray comprises four tray panels.

8. The food container of claim 1, wherein the skeleton structure of the lid defines four corners of the lid.

9. The food container of claim 1, wherein the skeleton structure of the lid protrudes vertically above an uppermost horizontal panel of the lid to define a plurality of corner stops, the corner stops configured to horizontally enclose a lowermost panel of the tray.

10. The food container of claim 1, wherein an upper horizontally extending panel of the lid includes a plurality of micro-perforations configured to vent the volume when the tray and lid are enclosed along the liquid-proof interface.

11. The food container of claim 1, wherein one of the panels is transparent or translucent.

12. The food container of claim 1, wherein the tray and lid are joined by a unitary hinge; and wherein the unitary hinge is formed of the first material.

13. The food container of claim 1, wherein the panels of the tray include a horizontally extending bottom panel and a plurality of tray side panels extending upwardly from the bottom panel, wherein the skeleton structure of the tray joins adjacent edges of the tray side panels.

14. The food container of claim 1, wherein the panels of the lid include a horizontally extending top panel and a plurality of lid side panels extending downwardly from the top panel, wherein the skeleton structure of the tray joins adjacent edges of the lid side panels.

15. The food container of claim 1, wherein the skeleton structure of the tray includes a lid-engaging portion extending about a perimeter of the tray, the lid-engaging portion having a plurality of laterally-extending surfaces spaced vertically apart by one or more perimeter walls.

16. The food container of claim 15, wherein the lid includes a channel configured to receive one of the laterally-extending surfaces to seal the lid to the tray about the perimeter of the tray.

17. A food container, comprising:
a tray defining a volume for receiving a food item, the tray including:
four tray panels formed of a first material; and
a tray skeleton structure joining adjacent edges of the panels to form four corners, the skeleton structure formed of a second material different from the first material; and
a lid configured to enclose the volume of the tray along a liquid-proof interface between the lid and tray, the lid including:
one or more lid panels formed of the first material; and
a lid skeleton structure forming a perimeter of the lid, the lid skeleton structure formed of a second material different from the first material, the lid skeleton structure defining four corners corresponding to the four corners of the tray.

18. The food container of claim 17, wherein the first material is a fibrous material.

19. The food container of claim 18, wherein the second material is a resin material.

20. A method of making a food container, comprising:
forming a tray defining a volume for receiving a food item, including:
providing a plurality of tray panels; and
joining adjacent edges of the plurality of tray panels with a tray skeleton structure to form one or more tray corners; and
forming a lid configured to enclose the volume of the tray along a liquid-proof interface between the lid and tray, including:
providing one or more lid panels; and
adhering edges of the one or more lid panels to a lid skeleton structure to form one or more lid corners;
wherein the tray panels and the one or more lid panels are each formed of a fibrous material, and wherein the tray skeleton structure and the lid skeleton structure are each formed of a resin material.
